(19) United States
(12) Patent Application Publication
(10) Pub. No.: US 2026/0299095 A1
(43) Pub. Date: Oct. 1, 2026

(54) DISTANCE IMAGE CAPTURING ELEMENT AND DISTANCE IMAGE CAPTURING DEVICE

(71) Applicant: TOPPAN Holdings Inc., Tokyo (JP)

(72) Inventors: Masaya OISHI, Tokyo (JP); Tomohiko KOSUGI, Tokyo (JP); Tetsuya IIDA, Tokyo (JP)

(73) Assignee: TOPPAN Holdings Inc., Tokyo (JP)

(21) Appl. No.: 19/575,199

(22) Filed: Mar. 23, 2026

(30) Foreign Application Priority Data
Mar. 26, 2025 (JP) 2025-051799

(51) Int. Cl. G01S 7/4863; G01S 7/4865; G01S 17/10; G01S 17/894

(52) U.S. Cl. CPC G01S 7/4863; G01S 7/4865; G01S 17/10; G01S 17/894

(57) ABSTRACT

A distance image capturing element includes: a pixel array in which a plurality of pixels are arranged in a two-dimensional matrix; and a pixel drive circuit that drives the pixels, in which each pixel includes m select transistors that output voltage signals corresponding to amounts of charge accumulated in m charge accumulation units, in the pixel array, in an m×m binning operation, a first pixel that outputs a binned addition value of a specific voltage signal corresponding to an amount of charge accumulated in one of the m charge accumulation units included in the pixel, and a second pixel that does not output the binned addition value of the specific voltage signal are arranged, and a control terminal of a select transistor of the first pixel and a control terminal of the select transistor of the second pixel are connected to different selection signals.

### BACKGROUND OF THE INVENTION

### Field of the Invention

The present invention relates to a distance image capturing element and a distance image capturing device.

Priority is claimed on Japanese Patent Application No. 2025-051799, filed on Mar. 26, 2025, the content of which is incorporated herein by reference.

### Description of Related Art

A time-of-flight (hereinafter, referred to as “TOF”) distance image capturing device is known that measures a distance between a measurement device and a target object based on a time of flight of light in a space (measurement space), by taking advantage of the fact that the speed of light is known (for example, see Japanese Patent No. 4235729).

Such a distance image capturing device performs imaging using, for example, a distance image capturing element including a photoelectric conversion element such as a photodiode. In addition, a TOF distance image capturing device is known that includes a photoelectric conversion element that converts an amount of incident light into charge, and a distance image capturing element that distributes the charge converted by the photoelectric conversion element to a plurality of charge accumulation units and causes the plurality of charge accumulation units to accumulate the charge.

### SUMMARY OF THE INVENTION

Meanwhile, in the distance image capturing device, a binning operation of adding and using each pixel of the distance image capturing element may be performed. In a distance image capturing element in the related art, for example, in a case where pixels including four charge accumulation units are added in (4×4) pixels, reading out is performed using only one of four output signal lines (PIXOUT1 to PIXOUT4 shown in FIG. 21G), and reading out of a pixel signal of each of the four charge accumulation units takes a time of four pixel rows in a pixel array arranged in a two-dimensional matrix.

The present invention has been made to solve the above-described problems, and an object of the present invention is to provide a distance image capturing element and a distance image capturing device capable of shortening a time required for reading out a pixel signal of each of a plurality of charge accumulation units during a binning operation.

The present invention relates to a distance image capturing element including: a pixel array in which a plurality of pixels are arranged in a two-dimensional matrix; and a pixel drive circuit that drives the pixels, in which the pixels each includes one photoelectric conversion element that generates charge corresponding to incident light, m (m is an integer of 2 or more) charge accumulation units that accumulate the charge, and m select transistors that are provided to correspond to the m charge accumulation units and output voltage signals corresponding to amounts of charge accumulated in the charge accumulation units, in the pixel array, in an m×m binning operation, a first pixel that outputs a binned addition value of a specific voltage signal corresponding to an amount of charge accumulated in one of the m charge accumulation units included in the pixels, and a second pixel that does not output the binned addition value of the specific voltage signal are arranged, and a control terminal of a specific select transistor that outputs an added value of the specific voltage signal among the m select transistors included in the first pixel, and a control terminal of the specific select transistor included in the second pixel are connected to different selection signals.

The present invention relates to a distance image capturing device including: a light source unit that irradiates a subject with a light pulse; a light receiving unit including the distance image capturing element described above; and a distance image processing unit that controls the pixel drive circuit so that the charge is accumulated in each of the charge accumulation units, outputs a binned addition value of a voltage signal corresponding to an amount of charge accumulated in each of the charge accumulation units, and calculates a distance to the subject based on the binned addition value corresponding to each of the charge accumulation units.

According to the present invention, it is possible to shorten the time required for reading out the pixel signal of each of the plurality of charge accumulation units during the binning operation.

### BRIEF DESCRIPTION OF THE DRAWINGS

FIG. 1 is a block diagram showing a configuration example of a distance image capturing device common to the embodiments.

FIG. 2 is a block diagram showing a configuration example of a distance image capturing element common to the embodiments.

FIG. 3 is a diagram showing an example of pixel arrangement in a pixel array common to the embodiments.

FIG. 4 is a diagram showing an example of a wiring image in the pixel array common to the embodiments.

FIG. 5 is a diagram showing an example of a pixel A of a first embodiment.

FIG. 6 is a diagram showing an example of a pixel B according to the first embodiment.

FIG. 7 is a diagram showing an example of a pixel C according to the first embodiment.

FIG. 8 is a diagram showing an example of a pixel D according to the first embodiment.

FIG. 9 is a diagram showing an example of a pixel E according to the first embodiment.

FIG. 10 is a diagram showing an example of a wiring image in the pixel array according to the first embodiment.

FIG. 11 is a timing chart showing driving of a pixel during a binning operation in the first embodiment.

FIG. 12 is a diagram showing an example of a pixel A of a second embodiment.

FIG. 13 is a diagram showing an example of a pixel B according to the second embodiment.

FIG. 14 is a diagram showing an example of a pixel C according to the second embodiment.

FIG. 15 is a diagram showing an example of a pixel D according to the second embodiment.

FIG. 16 is a diagram showing an example of a pixel E according to the second embodiment.

FIG. 17 is a diagram showing an example of a wiring image in the pixel array according to the second embodiment.

FIG. 18 is a timing chart showing driving of a pixel during a binning operation in the second embodiment.

FIG. 19 is a diagram showing examples of a pixel arrangement that can be adopted in the embodiment.

FIG. 20 is a diagram showing examples of a pixel arrangement that cannot be adopted in the embodiment.

FIG. 21A is a diagram showing a pixel in the related art.

FIG. 21B is a diagram showing a pixel in the related art.

FIG. 21C is a diagram showing a pixel in the related art.

FIG. 21D is a diagram showing a pixel in the related art.

FIG. 21E is a diagram showing a pixel in the related art.

FIG. 21F is a diagram showing a pixel in the related art.

FIG. 21G is a diagram showing a pixel in the related art.

### DETAILED DESCRIPTION OF THE INVENTION

Hereinafter, a distance image capturing element and a distance image capturing device of an embodiment will be described with reference to the accompanying drawings.

### Items Common to Embodiments

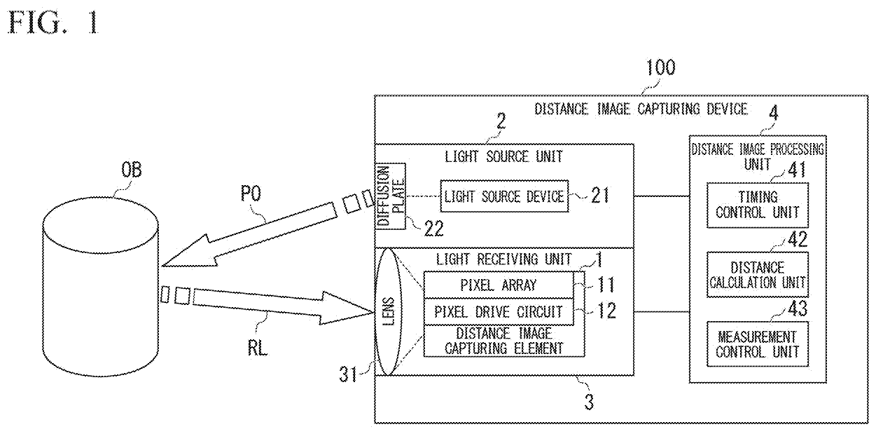

FIG. 1 is a block diagram showing a configuration example of the distance image capturing device common to the embodiments. A distance image capturing device 100 includes, for example, a light source unit 2, a light receiving unit 3, and a distance image processing unit 4. FIG. 1 also shows a subject OB that is a target object of which a distance is measured by the distance image capturing device 100.

The light source unit 2 irradiates the subject OB with a light pulse PO in accordance with control of the distance image processing unit 4. The light source unit 2 is, for example, a surface emitting type semiconductor laser module such as a vertical cavity surface emitting laser (VCSEL). The light source unit 2 includes a light source device 21 and a diffusion plate 22.

The light source device 21 is a light source that emits laser light in a near-infrared wavelength range (for example, a wavelength range of 850 nm to 940 nm) that is the light pulse PO with which the subject OB is irradiated. The light source device 21 is, for example, a semiconductor laser light-emitting element. The light source device 21 emits pulsed laser light in accordance with control of a measurement control unit 43.

The diffusion plate 22 is an optical component that diffuses the laser light in the near-infrared wavelength range emitted by the light source device 21 to the size of a surface of the subject OB irradiated with the laser light. The pulsed laser light diffused by the diffusion plate 22 is emitted as the light pulse PO for irradiating the subject OB present in a measurement space.

The light receiving unit 3 receives reflected light RL of the light pulse PO reflected by the subject OB and outputs a pixel signal corresponding to the received reflected light RL. The light receiving unit 3 includes a lens 31 and a distance image capturing element 1.

The lens 31 is an optical lens that guides the incident reflected light RL to the distance image capturing element 1. The lens 31 emits the incident reflected light RL to the distance image capturing element 1 side and causes the pixel included in a light reception region of the distance image capturing element 1 to receive (receive incidence of) the reflected light RL.

The distance image capturing element 1 is an imaging element used in the distance image capturing device 100.

The distance image processing unit 4 controls the distance image capturing device 100 and calculates a distance to the subject OB. The distance image processing unit 4 measures the distance to the subject OB present in the measurement space as a measurement distance based on an amount of charge accumulated in each of the charge accumulation units CS.

In addition, the distance image processing unit 4 includes a timing control unit 41, a distance calculation unit 42, and the measurement control unit 43.

The timing control unit 41 controls a timing of outputting various control signals required for measurement in accordance with control of the measurement control unit 43. The various control signals here are, for example, a signal for controlling the irradiation with the light pulse PO, a signal for distributing and accumulating the reflected light RL in the plurality of charge accumulation units CS, and a signal for controlling the number of times accumulation is performed per frame. The number of times accumulation is the number of times that the processing of distributing and accumulating the charge in the charge accumulation unit CS is repeated, and is the number of times distribution set in advance in a frame cycle. Thu, an exposure time is the product of the number of times accumulation and a time width (accumulation time width) for accumulating the charge in each charge accumulation unit CS per processing of distributing and accumulating the charge.

The distance calculation unit 42 outputs distance information obtained by calculating the distance to the subject OB based on the pixel signal output from the distance image capturing element 1. The distance calculation unit 42 calculates a delay time from the irradiation with the light pulse PO to the reception of the reflected light RL based on the amounts of charge accumulated in the plurality of charge accumulation units CS. The distance calculation unit 42 calculates the distance to the subject OB in accordance with the calculated delay time.

The distance calculation unit 42 calculates the delay time Td by, for example, Expression (1). In Expression (1), it is assumed that an amount of charge corresponding to an external light component included in the amounts of charge accumulated in charge accumulation units CS1 and CS2 is the same as an amount of charge accumulated in a charge accumulation unit CS3.

$$Td = To \times ( Q 2 - Q 3 ) / ( Q 1 + Q 2 - 2 \times Q 3 ) \qquad Expression ( 1 )$$

Here, To is a period during which the irradiation with the light pulse PO is performed.

Q1 is the amount of charge accumulated in the charge accumulation unit CS1.

Q2 is the amount of charge accumulated in the charge accumulation unit CS2.

Q3 is the amount of charge accumulated in the charge accumulation unit CS3.

The distance calculation unit 42 calculates a round-trip distance to the subject OB by multiplying the delay time Td obtained by Expression (1) by the speed of light (velocity) in a short-range light reception pixel. The distance calculation unit 42 measures the distance to the subject OB by halving the round-trip distance calculated above.

The measurement control unit 43 controls the timing control unit 41. For example, the measurement control unit 43 sets the number of times integration and the accumulation time in one frame, and controls the timing control unit 41 such that the imaging is performed with the set content.

With such a configuration, in the distance image capturing device 100, the light receiving unit 3 receives the reflected light RL in which the light pulse PO in the near-infrared wavelength range with which the subject OB is irradiated by the light source unit 2 is reflected by the subject OB, and the distance image processing unit 4 outputs the distance information (distance image) obtained by measuring the distance to the subject OB.

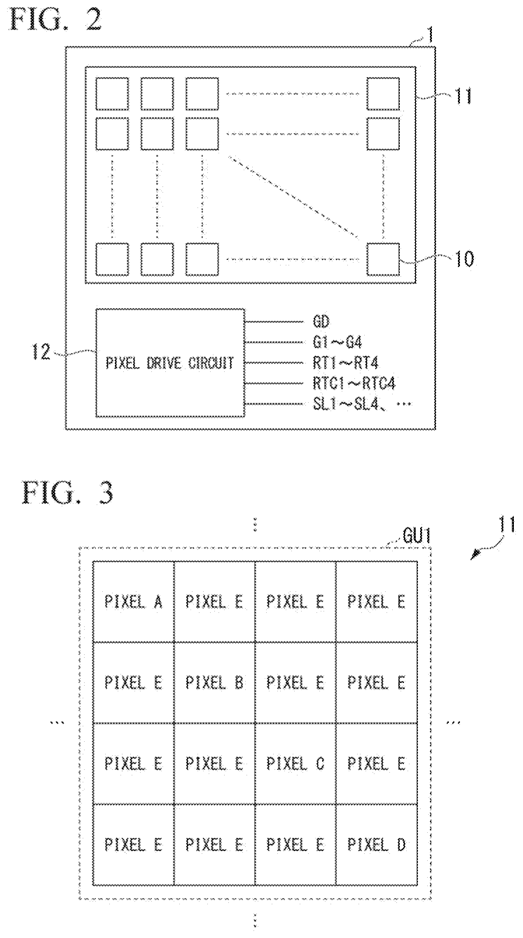

FIG. 2 is a block diagram showing a configuration example of the distance image capturing element common to the embodiments. In the pixel array 11, a plurality of pixels 10 are arranged in a two-dimensional matrix.

The pixel 10 included in the pixel array 11 includes, for example, one photoelectric conversion element PD, a plurality of charge accumulation units CS corresponding to the one photoelectric conversion element PD, and a component that distributes the charge to each of the charge accumulation units CS. A detailed configuration of the pixel 10 according to the present embodiment will be described later with reference to the accompanying drawings.

The pixel drive circuit 12 drives the pixel 10 by controlling the output of the control signals (control signals GD, G1 to G4, RT1 to RT4, RTC1 to RTC4, SL1 to SL4, . . . ), and distributes and accumulates the charge in each of the charge accumulation units CS at a predetermined accumulation timing synchronized with the irradiation with the light pulse PO. The pixel drive circuit 12 repeats the accumulation processing the number of times accumulation per frame, and then outputs the pixel signal corresponding to the amount of charge accumulated in a readout period.

In addition, the pixel drive circuit 12 controls the output of the control signal such that the pixel signal obtained by adding the plurality of pixels 10 (binning addition) is output in a binning mode.

Hereinafter, a case where a pixel unit GU1 configured with a matrix of 4 pixels×4 pixels is used as a unit for performing binning will be described as an example, but the present invention is not limited to this, and the present embodiment can be applied to a case where m pixels×m pixels are used as a unit for performing binning. Here, m is an integer of 2 or more, and the number of charge accumulation units CS included in one pixel is m or less than m.

FIG. 3 is a diagram showing an example of pixel arrangement in the pixel array common to the embodiments.

In this diagram, an example of pixel arrangement in the pixel unit GU1 configured with the matrix of 4 pixels×4 pixels, which is the unit for performing binning, is shown. The pixel array 11 is formed by the repetition of the pixel unit GU1.

Hereinafter, a horizontal axis in a plan view of a pixel surface of the pixel unit GU1 is referred to as an X direction axis, and a vertical axis is referred to as a Y direction axis. In addition, the arrangement of the pixels will be described with position coordinates (x, y) in which an upper left corner of the pixel unit GU1 is an origin (0, 0), a right direction is a positive X axis direction, and a down direction is a positive Y axis direction.

As shown in FIG. 3, the pixel array 11 includes five types of pixels 10: a pixel A to a pixel E. The pixel A corresponds to a type-A pixel 10-A that will be described later. The pixel B corresponds to a type-B pixel 10-B that will be described later. The pixel C corresponds to a type-C pixel 10-C that will be described later. The pixel D corresponds to a type-D pixel 10-D that will be described later. The pixel E corresponds to a type-E pixel 10-E that will be described later.

Among the five types of pixels 10, the pixel A to the pixel D are arranged along an oblique straight line corresponding to a diagonal line of a quadrangle formed by the matrix of 4 pixels×4 pixels in the pixel unit GU1, and the pixel E is arranged at other positions.

Specifically, the pixel A is arranged at position coordinates (1, 1) in the pixel unit GU1. The pixel B is arranged at position coordinates (2, 2) in the pixel unit GU1. The pixel C is arranged at position coordinates (3, 3) in the pixel unit GU1. The pixel D is arranged at position coordinates (4, 4) in the pixel unit GU1. The pixel E is arranged at positions at which the pixel A to the pixel D are not arranged in the pixel unit GU1, that is, at position coordinates (1, 2), (1, 3), (1, 4), (2, 1), (2, 3), (2, 4), (3, 1), (3, 2), (3, 4), (4, 1), (4, 2), and (4, 3).

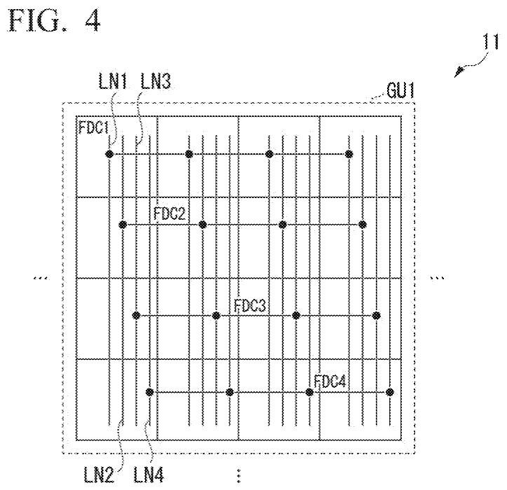

FIG. 4 is a diagram showing an example of a wiring image in the pixel array common to the embodiments.

In the pixel unit GU1 of the pixel array 11 shown in this diagram, the pixel A is arranged at position coordinates (1, 1) as in FIG. 3. The pixel B is arranged at position coordinates (2, 2). The pixel C is arranged at position coordinates (3, 3). The pixel D is arranged at position coordinates (4, 4). The pixel E is arranged at positions other than the positions at which the pixel A to the pixel D are arranged in the pixel unit GU1.

In this diagram, a wiring LN1 indicates a wiring of a floating diffusion FDC1, and a wiring LN2 indicates a wiring of a floating diffusion FDC2. Further, a wiring LN3 indicates a wiring of a floating diffusion FDC3, and a wiring LN4 indicates a wiring of a floating diffusion FDC4.

The floating diffusions FDC (FDC1 to FDC4) are signal lines that output the added charge in the binning operation.

More specifically, the floating diffusion FDC1 is a signal line that outputs a pixel signal corresponding to an added value of the charge accumulated in the charge accumulation unit CS1 for each of the pixels constituting the pixel unit GU1 in the binning operation. The floating diffusion FDC2 is a signal line that outputs a pixel signal corresponding to an added value of the charge accumulated in the charge accumulation unit CS2 for each of the pixels constituting the pixel unit GU1 in the binning operation. The floating diffusion FDC3 is a signal line that outputs a pixel signal corresponding to an added value of the charge accumulated in the charge accumulation unit CS3 for each of the pixels constituting the pixel unit GU1 in the binning operation. The floating diffusion FDC4 is a signal line that outputs a pixel signal corresponding to an added value of the charge accumulated in the charge accumulation unit CS4 for each of the pixels constituting the pixel unit GU1 in the binning operation.

As shown in this diagram, by wiring the wirings LN1 to LN4 of the floating diffusions FDC (FDC1 to FDC4), the floating diffusions FDC (FDC1 to FDC4) can be shared in 4 pixels×4 pixels in the pixel unit GU1, and the charge added in the binning operation can be output.

### Pixel in Related Art

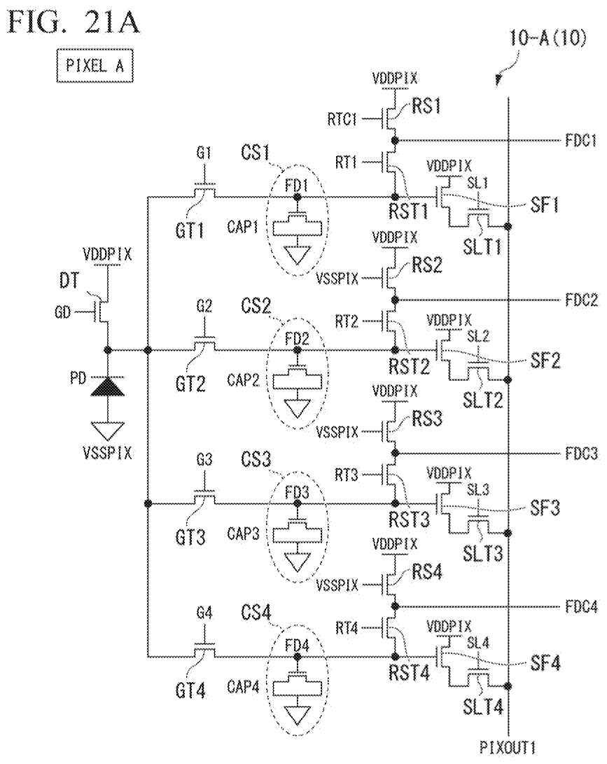

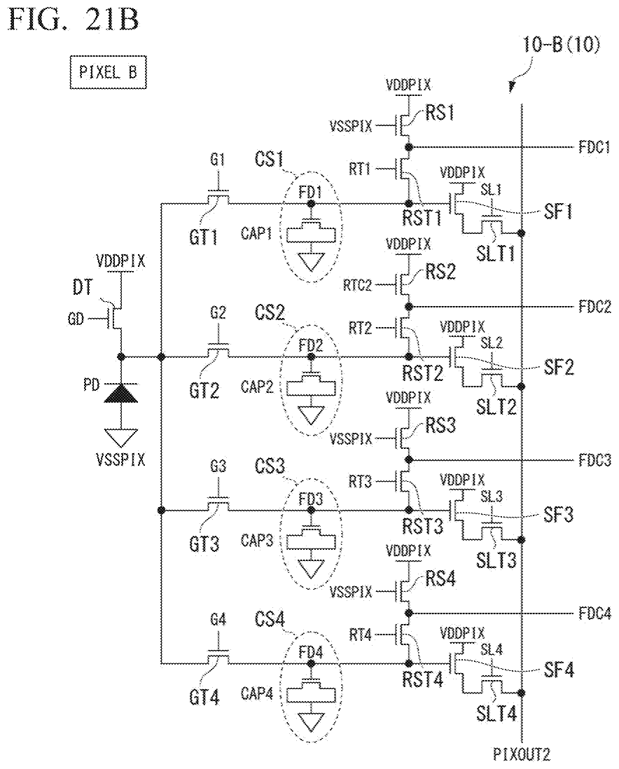

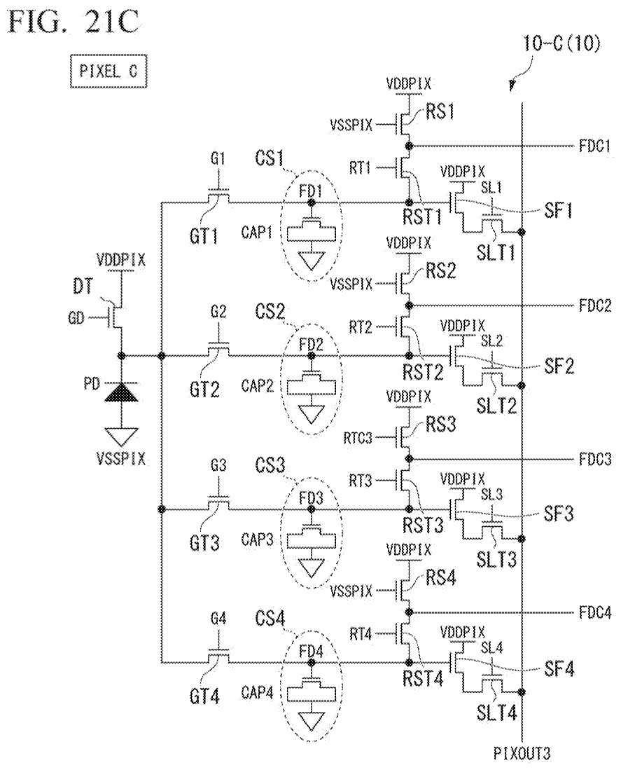

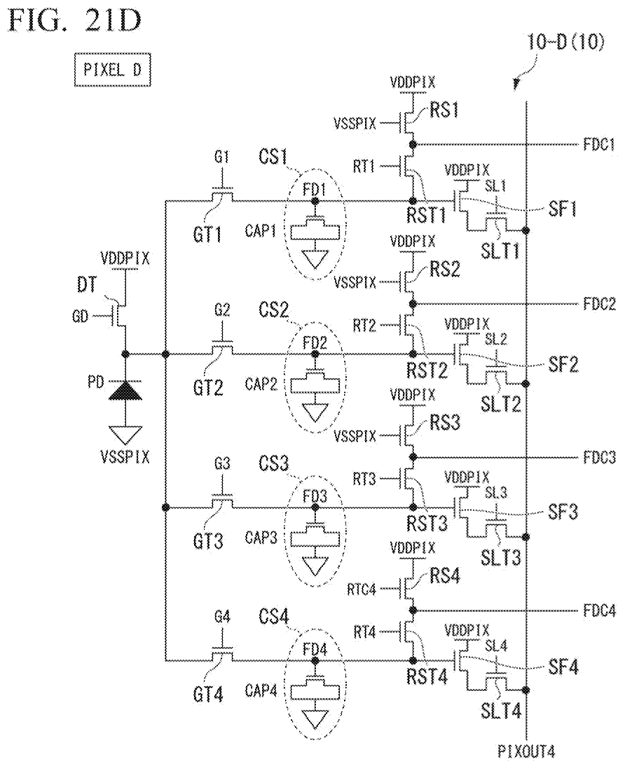

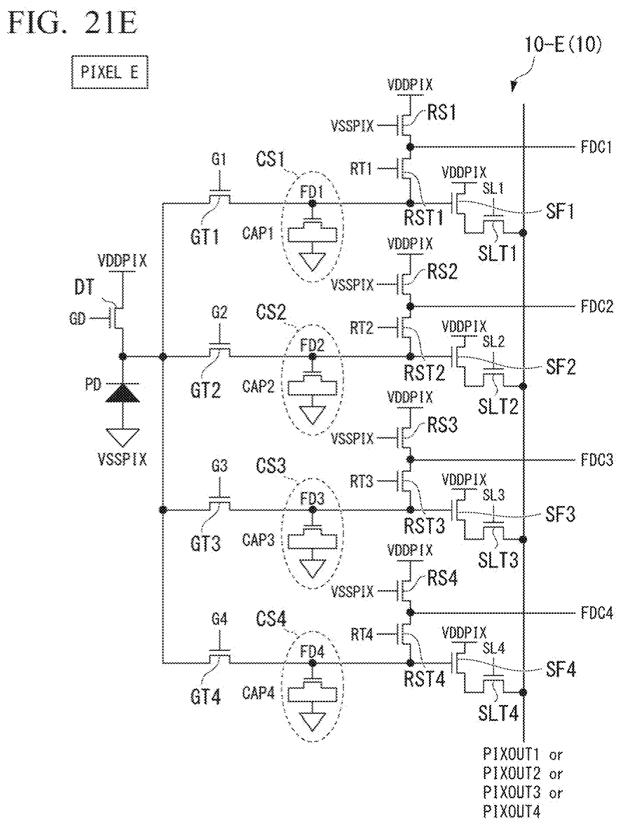

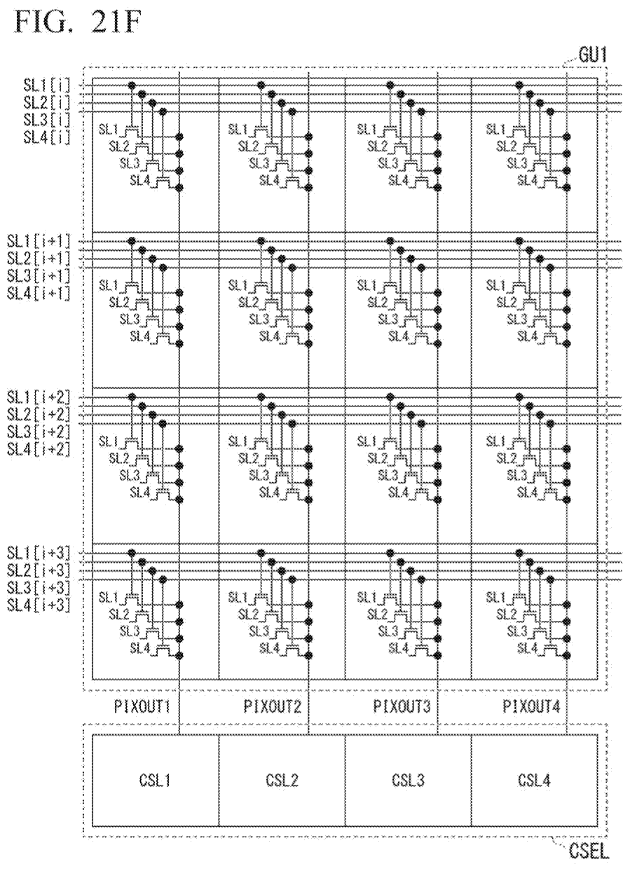

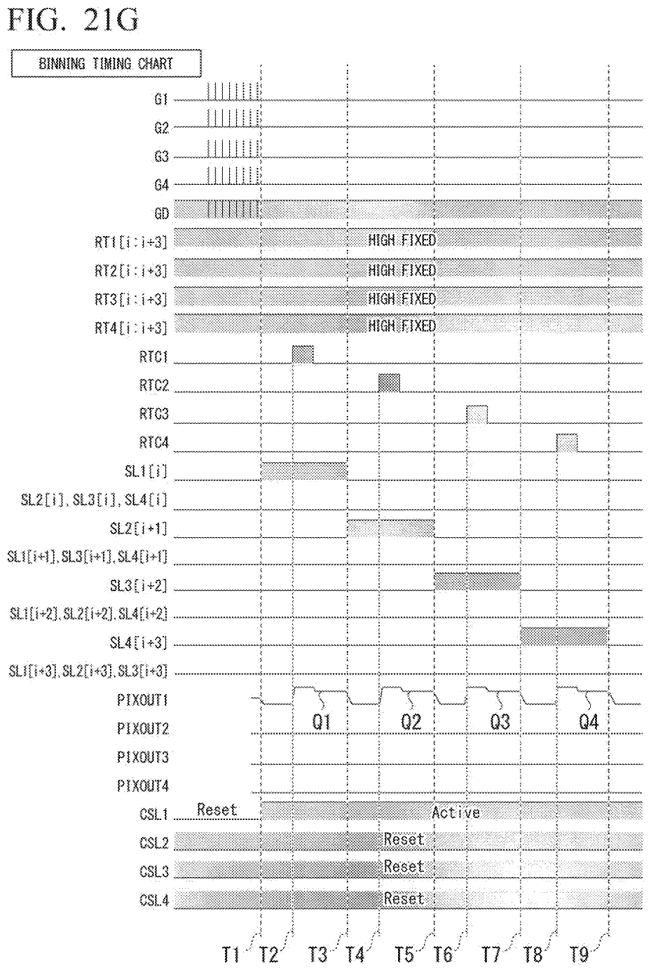

Here, the pixel in the related art will be described with reference to FIG. 21 (FIGS. 21A to 21G). FIG. 21 is a diagram showing the pixel in the related art.

FIG. 21A shows an example of the pixel 10-A that is the type-A pixel (pixel A) in the related art.

As shown in FIG. 21A, the pixel 10-A includes one photoelectric conversion element PD, four transfer transistors GT (GT1 to GT4), one charge discharge transistor DT, four reset transistors RST (RST1 to RST4), four capacitors CAP (CAP1 to CAP4), four source follower transistors SF (SF1 to SF4), four select transistors SLT (SLT1 to SLT4), and four control transistors RS (RS1 to RS4).

The photoelectric conversion element PD is a buried photodiode that photoelectrically converts incident light to generate the charge corresponding to the incident light (incidence light) and accumulates the generated charge. In the present embodiment, the incidence light is incident from a measurement target space. The photoelectric conversion element PD has an anode terminal connected to a ground power supply line and a cathode terminal connected to a source terminal of the transfer transistors GT (GT1 to GT4).

In the pixel A, the photoelectric conversion element PD distributes the charge generated by photoelectrically converting the incidence light to each of the four charge accumulation units CS (CS1 to CS4), and outputs each voltage signal (pixel signal) corresponding to the amount of charge of the distributed charge to the output line PIXOUT1.

The pixel drive circuit 12 controls the measurement control unit 43 to supply the control signals G (G1 to G4) for accumulation to the transfer transistors GT (GT1, GT2, GT3, and GT4) at each timing to switch the charge generated in the photoelectric conversion element PD in synchronization with the irradiation with the light pulse PO in the frame cycle, and accumulate the charge in the order of the charge accumulation units CS1, CS2, CS3, and CS4.

Here, the charge accumulation unit CS includes a floating diffusion FD and a capacitor CAP. That is, the charge accumulation unit CS1 includes a floating diffusion FD1 and a capacitor CAP1, and the charge accumulation unit CS2 includes a floating diffusion FD2 and a capacitor CAP2. In addition, the charge accumulation unit CS3 includes a floating diffusion FD3 and a capacitor CAP3, and the charge accumulation unit CS4 includes a floating diffusion FD4 and a capacitor CAP4.

The floating diffusions FD (FD1 to FD4) are wirings between the transfer transistors GT (GT1 to GT4) and the source follower transistors SF (SF1 to SF4).

The capacitors CAP (CAP1 to CAP4) are, for example, CMOS capacitors.

The transfer transistors GT (GT1 to GT4) are in a conducting state (ON state) due to the control signals G (G1 to G4), accumulate the charge generated by the photoelectric conversion element PD in the charge accumulation units CS (CS1 to CS4), and transfer the charge to the source follower transistors SF (SF1 to SF4).

The source follower transistors SF (SF1 to SF4) are transistors that convert the charge into electrical signals, and output the electrical signals (voltages) corresponding to the charge accumulated in the charge accumulation units CS (CS1 to CS4) to the select transistors SLT (SLT1 to SLT4).

The select transistors SLT (SLT1 to SLT4) select the reading out of the electrical signal of the pixel 10. The select transistors SLT (SLT1 to SLT4) are in a conducting state (ON state) due to the control signals SL (SL1 to SL4), and output the pixel value (output signal) to the output line PIXOUT1.

The reset transistors RST (RST1 to RST4) correspond to the charge accumulation units CS (CS1 to CS4), respectively, and reset the charge accumulation units CS (CS1 to CS4) to a predetermined reset potential supplied from a power supply line VDDPIX. The reset transistors RST (RST1 to RST4) are in a conducting state (ON state) due to the control signals RT (RT1 to RT4), and reset the charge accumulation units CS (CS1 to CS4) to a reset potential supplied from the power supply line VDDPIX via the control transistors RS (RS1 to RS4) that will be described later.

The control transistors RS (RS1 to RS4) are control transistors RS corresponding to the reset transistors RST (RST1 to RST4), and are connected between the reset transistors RST (RST1 to RST4) and the power supply line VDDPIX. The wiring between the control transistors RS (RS1 to RS4) and the reset transistors RST (RST1 to RST4) functions as the floating diffusions FDC (FDC1 to FDC4) that output the added charge in the binning mode in which the plurality of pixels 10 are added and used.

In the pixel A, the control terminal of the control transistor RS1 among the four control transistors RS (RS1 to RS4) is connected to the control signal RTC1 (control wiring) capable of controlling the ON state of the control transistor RS1. Further, the remaining three control transistors RS, that is, the control transistors RS2 to RS4 other than the control transistor RS1, are connected to the power supply line VSSPIX to fix the control transistors RS to an OFF state.

In the pixel A, the floating diffusion FDC1 is in the ON state due to the wiring of the control signal RTC1, and is reset to the reset potential supplied from the power supply line VDDPIX.

The charge discharge transistor DT is connected between the photoelectric conversion element PD and the power supply line VDDPIX, and discharges the charge from the photoelectric conversion element PD. The charge discharge transistor DT is in the ON state due to the control signal GD, and the charge generated in the photoelectric conversion element PD flows to the power supply line VDDPIX and is discharged (the charge is erased).

The transfer transistors GT (GT1 to GT4), the charge discharge transistor DT, the reset transistors RST (RST1 to RST4), the source follower transistors SF (SF1 to SF4), the select transistors SLT (SLT1 to SLT4), and the control transistors RS (RS1 to RS4) are N-channel metal oxide semiconductor (NMOS) transistors.

FIG. 21B shows an example of the pixel 10-B that is the type-B pixel (pixel B) in the present embodiment.

The pixel B shown in FIG. 21B has the same basic configuration as the pixel A described above, but has different connection of the control signal of the control transistors RS (RS1 to RS4) and the output line of the voltage signal (pixel signal).

In the pixel B, the control terminal of the control transistor RS2 among the four control transistors RS (RS1 to RS4) is connected to the control signal RTC2 (control wiring) capable of controlling the ON state of the control transistor RS2. Further, the remaining three control transistors RS, that is, the control transistors RS1 and RS3 to RS4 other than the control transistor RS2, are connected to the power supply line VSSPIX to fix the control transistor RS in the OFF state.

In the pixel B, the floating diffusion FDC2 is in the ON state due to the wiring of the control signal RTC2, and is reset to the reset potential supplied from the power supply line VDDPIX.

In addition, in the pixel B, the select transistors SLT (SLT1 to SLT4) are in the conducting state (ON state) due to the control signals SL (SL1 to SL4), and output the pixel value (output signal) to the output line PIXOUT2.

FIG. 21C shows an example of the pixel 10-C that is the type-C pixel (pixel C) in the present embodiment.

The pixel C shown in FIG. 21C has the same basic configuration as the pixel A described above, but has different connection of the control signal of the control transistors RS (RS1 to RS4) and the output line of the voltage signal (pixel signal).

In the pixel C, the control terminal of the control transistor RS3 among the four control transistors RS (RS1 to RS4) is connected to the control signal RTC3 (control wiring) capable of controlling the ON state of the control transistor RS3. Further, the remaining three control transistors RS, that is, the control transistors RS1 and RS2 and RS4 other than the control transistor RS3, are connected to the power supply line VSSPIX to fix the control transistor RS in the OFF state.

In the pixel C, the floating diffusion FDC3 is in the ON state due to the wiring of the control signal RTC3, and is reset to the reset potential supplied from the power supply line VDDPIX.

In addition, in the pixel C, the select transistors SLT (SLT1 to SLT4) are in the conducting state (ON state) due to the control signals SL (SL1 to SL4), and output the pixel value (output signal) to the output line PIXOUT3.

FIG. 21D shows an example of the pixel 10-D that is the type-D pixel (pixel D) in the present embodiment.

The pixel D shown in FIG. 21D has the same basic configuration as the pixel A described above, but has different connection of the control signal of the control transistors RS (RS1 to RS4) and the output line of the voltage signal (pixel signal).

In the pixel D, the control terminal of the control transistor RS4 among the four control transistors RS (RS1 to RS4) is connected to the control signal RTC4 (control wiring) capable of controlling the ON state of the control transistor RS4. Further, the remaining three control transistors RS, that is, the control transistors RS1 to RS3 other than the control transistor RS4, are connected to the power supply line VSSPIX to fix the control transistor RS in the OFF state.

In the pixel D, the floating diffusion FDC4 is in the ON state due to the wiring of the control signal RTC4, and is reset to the reset potential supplied from the power supply line VDDPIX.

In addition, in the pixel D, the select transistors SLT (SLT1 to SLT4) are in the conducting state (ON state) due to the control signals SL (SL1 to SL4), and output the pixel value (output signal) to the output line PIXOUT4.

FIG. 21E shows an example of the pixel 10-E that is the type-E pixel (pixel E) in the present embodiment.

The pixel E shown in FIG. 21E has the same basic configuration as the pixel A described above, but has different connection of the control signal of the control transistors RS (RS1 to RS4) and the output line of the voltage signal (pixel signal).

In the pixel E, all of the four control transistors RS (RS1 to RS4) are connected to the power supply line VSSPIX to fix the control transistor RS in the OFF state.

In addition, in the pixel E, the select transistors SLT (SLT1 to SLT4) are in the conducting state (ON state) due to the control signal SL (SL1 to SL4), and output the pixel value (output signal) to any one of the output lines PIXOUT1 to PIXOUT4.

Which output line the pixel E outputs the pixel value (output signal) to is determined in accordance with the row in which the pixel E is arranged in the pixel unit GU1.

In the pixel array in the related art, when the pixel arrangement is the arrangement shown in FIG. 3 and the wiring is as shown in FIG. 4, the pixel E arranged in the same row as the row in which the pixel A is arranged outputs the pixel value (output signal) to the output line PIXOUT1. The pixel E arranged in the same row as the row in which the pixel B is arranged outputs the pixel value (output signal) to the output line PIXOUT2. The pixel E arranged in the same row as the row in which the pixel C is arranged outputs the pixel value (output signal) to the output line PIXOUT3. The pixel E arranged in the same row as the row in which the pixel D is arranged outputs the pixel value (output signal) to the output line PIXOUT4.

As described above, in each of the four types of pixels of the pixel A to the pixel D, the position of the control transistor RS connected to the wiring of the control signals RTC (RTC1 to RTC4) is different among the four control transistors RS (RS1 to RS4). Further, in the pixel E, all of the four control transistors RS (RS1 to RS4) are fixed in the OFF state.

FIG. 21F is a diagram showing an example of a wiring image in the pixel array in the related art. In this diagram, i indicates a row number.

In the pixel unit GU1 of the pixel array 11 shown in this diagram, the pixel A is arranged at the left end of the i-th row, that is, at the position coordinates (1, 1). The pixel B is arranged at the second position from the left in the (i+1)-th row, that is, at the position coordinates (2, 2). The pixel C is arranged at the third position from the left in the (i+2)-th row, that is, at the position coordinates (3, 3). The pixel D is arranged at the fourth position from the left in the (i+3)-th row, that is, at the position coordinates (4, 4). The pixel E is arranged at positions other than the positions at which the pixel A to the pixel D are arranged in the pixel unit GU1.

In this diagram, the control signals SL (SL1 to SL4) for controlling the select transistors SLT (SLT1 to SLT4) included in each of the pixels arranged in the i-th row are set as the control signals SL1[i], SL2[i], SL3[i], and SL4[i].

The control signals SL (SL1 to SL4) for controlling the select transistors SLT (SLT1 to SLT4) included in each of the pixels arranged in the (i+1)-th row are set as the control signals SL1[i+1], SL2[i+1], SL3[i+1], and SL4[i+1].

The control signals SL (SL1 to SL4) for controlling the select transistors SLT (SLT1 to SLT4) included in each of the pixels arranged in the (i+2)-th row are set as the control signals SL1[i+2], SL2[i+2], SL3[i+2], and SL4[i+2].

The control signals SL (SL1 to SL4) for controlling the select transistors SLT (SLT1 to SLT4) included in each of the pixels arranged in the (i+3)-th row are set as the control signals SL1[i+3], SL2[i+3], SL3[i+3], and SL4[i+3].

The output signals PIXOUT1 to PIXOUT4 are input to the selection circuit CSEL. The selection circuit CSEL controls the output of the output signals of the output lines PIXOUT1 to PIXOUT4 in accordance with the control signals CSL (CSL1 to CSL4).

The pixel drive circuit 12 causes the selection circuit CSEL to output, from the selection circuit CSEL, the output signal of the output line PIXOUT corresponding to the control signals CSL (CSL1 to CSL4) that have been made active, by making the control signals CSL (CSL1 to CSL4) active with respect to the selection circuit CSEL. That is, the output signal of the output line PIXOUTn is output by making the control signal CSLn active. When the control signal CSLn is inactive (reset), the output signal of the output line PIXOUTn is reset. The subscript n of the output line PIXOUT is an integer of 1 to 4.

FIG. 21G is a timing chart showing the driving of the pixel in the related art. In this diagram, a horizontal axis represents time, and a vertical axis represents a waveform of a control signal.

As the control signals, in order from the top as control signals G1 to G4, a control signal GD, control signals RT1[i:i+3], RT2[i:i+3], RT3[i:i+3], and RT4[i:i+3], control signals RTC1 to RTC4, control signals SLn[i+k], output signals PIXOUT1 to PIXOUT4, and control signals CSL1 to CSL4 are shown. However, the subscript n of the control signal SL is an integer of 1 to 4, k is an integer of 0 to 3, and i indicates a row number.

In the binning operation, the pixel drive circuit 12 first fixes the control signal RT to a high (H) state and fixes the reset transistors RST (RST1 to RST4) of all the pixels in the pixel unit GU1 to the ON state. Further, the pixel drive circuit 12 fixes the control signals SL2[i], SL3[i], and SL4[i] to a low (L) state. The pixel drive circuit 12 fixes the control signals SL1[i+1], SL3[i+1], and SL4[i+1] to the L state. The pixel drive circuit 12 fixes the control signals SL1[i+2], SL2[i+2], and SL4[i+2] to the L state. The pixel drive circuit 12 fixes the control signals SL1[i+3], SL2[i+3], and SL3[i+3] to the L state. In addition, the pixel drive circuit 12 resets the output of the selection circuit CSEL by setting the control signals CSL (CSL1 to CSL4) to the L state.

In a period up to time T1, the pixel drive circuit 12 turns on the transfer transistors GT (GT1 to GT4) by the control signals G (G1 to G4) and causes the charge accumulation units CS (CS1 to CS4) to accumulate the charge. Further, the pixel drive circuit 12 turns off the charge discharge transistor DT by the control signal GD while the charge accumulation units CS (CS1 to CS4) accumulate the charge.

At the time T1, the pixel drive circuit 12 sets the control signal SL1[i] to the H state and sets the control signal CSL1 to the H state (active), thereby causing the pixel A to output, to the output line PIXOUT1, the pixel value (output signal) corresponding to the charge accumulated in the charge accumulation unit CS1, which has been summed by binning.

At time T2, the pixel drive circuit 12 sets the control signal RTC1 to the H state to reset the charge accumulated in the charge accumulation unit CS1 in the pixel unit GU1.

At the time T1, the pixel drive circuit 12 sets the control signal SL1[i] to the H state and sets the control signal CSL1 to the H state, thereby causing the pixel A to output, to the output line PIXOUT1, the pixel value (output signal) corresponding to the charge Q1 accumulated in the charge accumulation unit CS1, which has been summed by binning.

At the time T2, the pixel drive circuit 12 sets the control signal RTC1 to the H state to reset the charge accumulated in the charge accumulation unit CS1 in the pixel unit GU1.

At time T3, the pixel drive circuit 12 sets the control signal SL1[i] to the L state and sets the control signal SL2[i+1] to the H state, thereby causing the pixel B to output, to the output line PIXOUT1, the pixel value (output signal) corresponding to the charge Q2 accumulated in the charge accumulation unit CS2, which has been summed by binning.

At time T4, the pixel drive circuit 12 sets the control signal RTC2 to the H state to reset the charge accumulated in the charge accumulation unit CS2 in the pixel unit GU1.

At time T5, the pixel drive circuit 12 sets the control signal SL2[i+1] to the L state and sets the control signal SL3[i+2] to the H state, thereby causing the pixel C to output, to the output line PIXOUT1, the pixel value (output signal) corresponding to the charge Q3 accumulated in the charge accumulation unit CS3, which has been summed by binning.

At time T6, the pixel drive circuit 12 sets the control signal RTC3 to the H state to reset the charge accumulated in the charge accumulation unit CS3 in the pixel unit GU1.

At time T7, the pixel drive circuit 12 sets the control signal SL3[i+2] to the L state and sets the control signal SL4[i+3] to the H state, thereby causing the pixel D to output, to the output line PIXOUT1, the pixel value (output signal) corresponding to the charge Q4 accumulated in the charge accumulation unit CS4, which has been summed by binning.

At time T8, the pixel drive circuit 12 sets the control signal RTC4 to the H state to reset the charge accumulated in the charge accumulation unit CS4 in the pixel unit GU1.

At time T9, the pixel drive circuit 12 sets the control signal RTC4 to the L state.

As described above, in the binning operation in the related art, the reading out of the output signal is performed using only one (PIXOUT1) of the four output lines PIXOUT1 to PIXOUT4. Therefore, it takes a readout time of four lines to read out four output signals corresponding to the charge Q1 to the charge Q4 accumulated in the charge accumulation units CS1 to CS4.

### First Embodiment

Here, the first embodiment will be described. In the present embodiment, the control signals SL (SL1 to SL4) of the pixel A, the pixel B, the pixel C, and the pixel D can be controlled for each pixel.

Specifically, the four control signals SL (SL1 to SL4) in the related art are set to 16 control signals SL1A to SL4A corresponding to the pixel A, control signals SL1B to SL4B corresponding to the pixel B, control signals SL1C to SL4C corresponding to the pixel C, and control signals SL1D to SL4D corresponding to the pixel D. As a result, the selection of the select transistor SLT can be controlled for each column.

The configuration of the pixel 10 (pixel A to pixel E) in the first embodiment is the same as the configuration of the pixel (pixel A to pixel E) in the related art, except for the connection of the control signal SL.

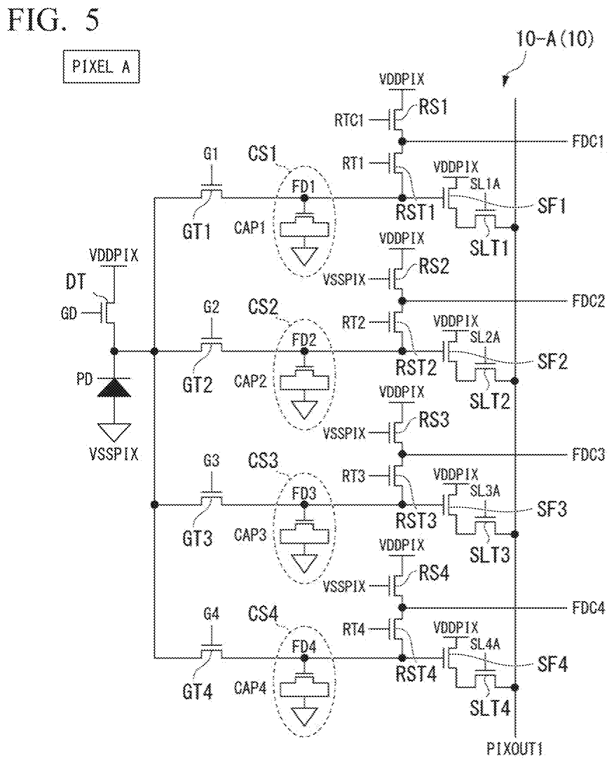

FIG. 5 is a diagram showing an example of the pixel A according to the first embodiment.

As shown in FIG. 5, the basic configuration of the pixel A according to the first embodiment is the same as that of the pixel A in the related art, but has different connection of the control signal (selection signal) of the select transistor SLT (SLT1 to SLT4).

In the pixel A according to the first embodiment, the control terminal of the select transistor SLT1 is connected to the control signal SL1A. The control terminal of the select transistor SLT2 is connected to the control signal SL2A. The control terminal of the select transistor SLT3 is connected to the control signal SL3A. The control terminal of the select transistor SLT4 is connected to the control signal SL4A.

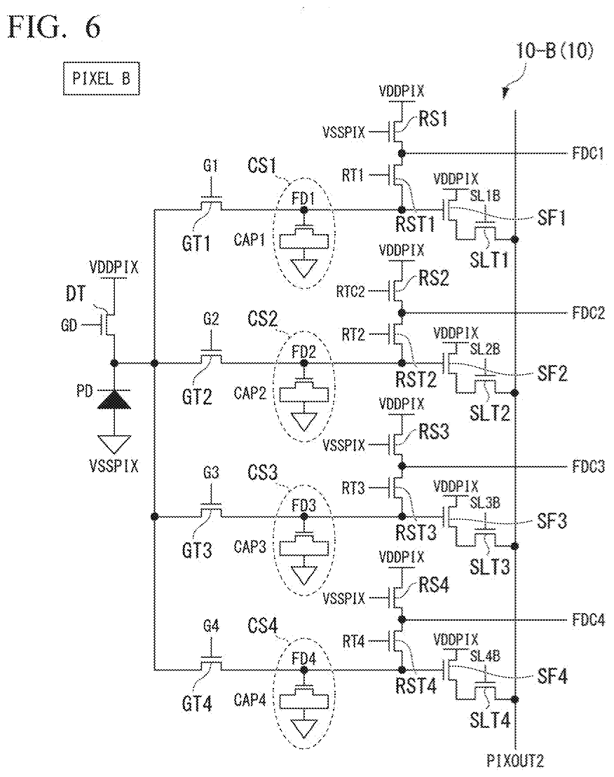

FIG. 6 is a diagram showing an example of the pixel B according to the first embodiment.

As shown in FIG. 6, the basic configuration of the pixel B according to the first embodiment is the same as that of the pixel B in the related art, but has different connection of the control signal (selection signal) of the select transistor SLT (SLT1 to SLT4).

In the pixel B according to the first embodiment, the control terminal of the select transistor SLT1 is connected to the control signal SL1B. The control terminal of the select transistor SLT2 is connected to the control signal SL2B. The control terminal of the select transistor SLT3 is connected to the control signal SL3B. The control terminal of the select transistor SLT4 is connected to the control signal SL4B.

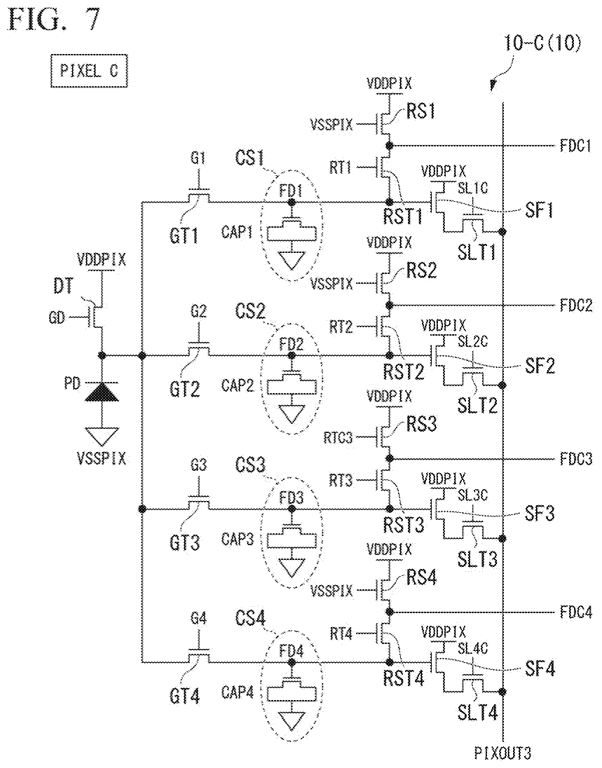

FIG. 7 is a diagram showing an example of the pixel C according to the first embodiment.

As shown in FIG. 7, the basic configuration of the pixel C according to the first embodiment is the same as that of the pixel C in the related art, but has different connection of the control signal (selection signal) of the select transistor SLT (SLT1 to SLT4).

In the pixel C according to the first embodiment, the control terminal of the select transistor SLT1 is connected to the control signal SL1C. The control terminal of the select transistor SLT2 is connected to the control signal SL2C. The control terminal of the select transistor SLT3 is connected to the control signal SL3C. The control terminal of the select transistor SLT4 is connected to the control signal SL4C.

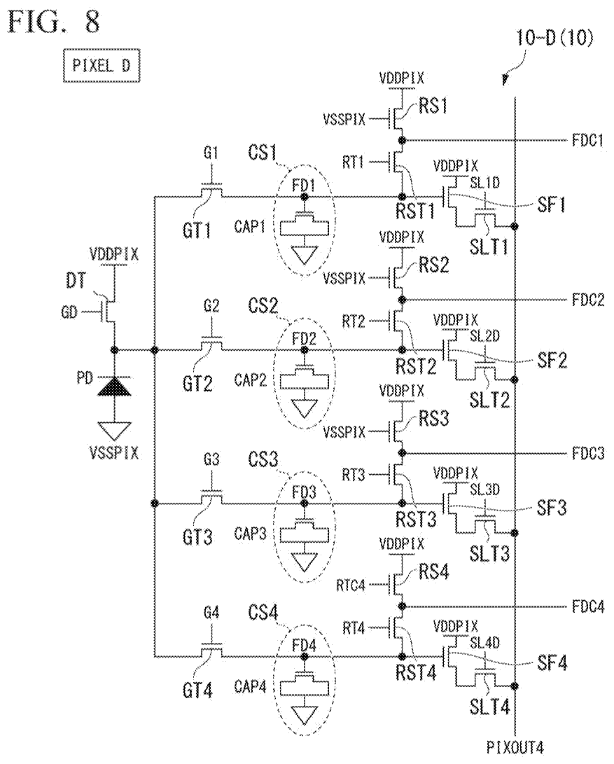

FIG. 8 is a diagram showing an example of the pixel D according to the first embodiment.

As shown in FIG. 8, the basic configuration of the pixel D according to the first embodiment is the same as that of the pixel D in the related art, but has different connection of the control signal (selection signal) of the select transistor SLT (SLT1 to SLT4).

In the pixel D according to the first embodiment, the control terminal of the select transistor SLT1 is connected to the control signal SL1D. The control terminal of the select transistor SLT2 is connected to the control signal SL2D. The control terminal of the select transistor SLT3 is connected to the control signal SL3D. The control terminal of the select transistor SLT4 is connected to the control signal SL4D.

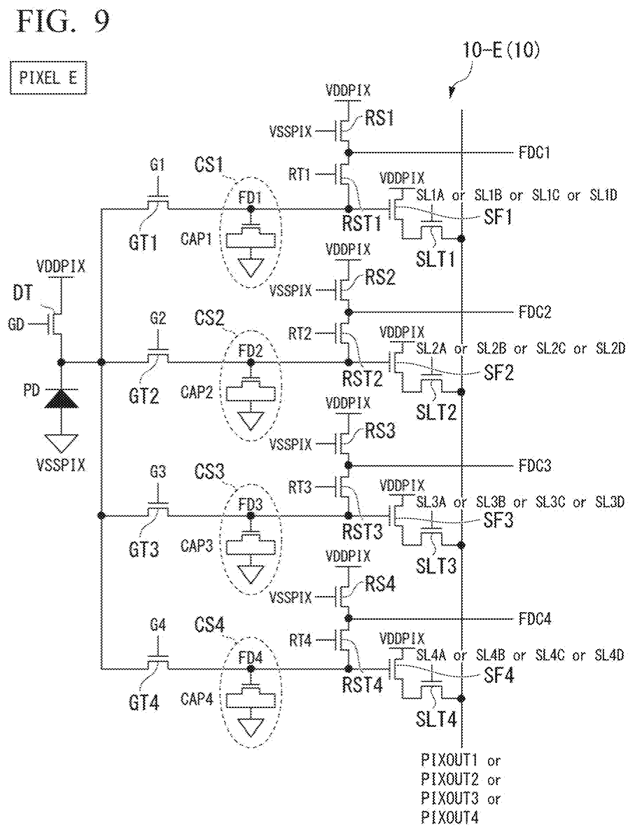

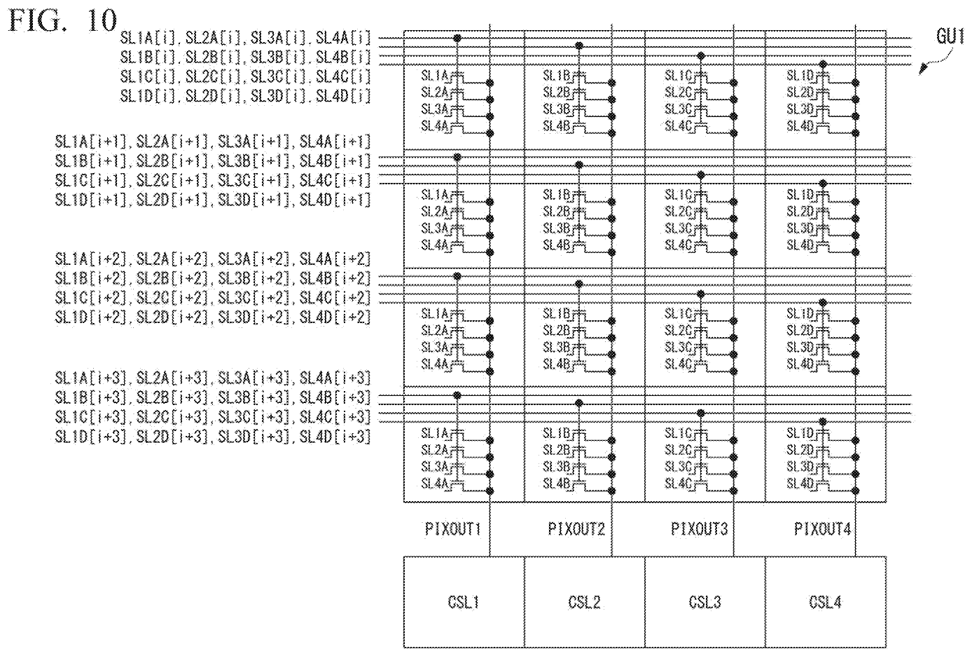

FIG. 9 is a diagram showing an example of the pixel E according to the first embodiment.

As shown in FIG. 9, the basic configuration of the pixel E according to the first embodiment is the same as that of the pixel E in the related art, but has different connection of the control signal (selection signal) of the select transistor SLT (SLT1 to SLT4).

In the pixel E according to the first embodiment, the control terminal of the select transistor SLT1 is connected to any one of the control signals SL1A to SL1D. Which control signal is connected to the select transistor SLT1 is determined in accordance with the column in which the pixel E is arranged in the pixel unit GU1. The select transistor SLT1 of the pixel E arranged in the same column as the column in which the pixel A is arranged is connected to the control signal SL1A. The select transistor SLT1 of the pixel E arranged in the same column as the column in which the pixel B is arranged is connected to the control signal SL1B. The select transistor SLT1 of the pixel E arranged in the same column as the column in which the pixel C is arranged is connected to the control signal SL1C. The select transistor SLT1 of the pixel E arranged in the same column as the column in which the pixel D is arranged is connected to the control signal SL1D.

In the pixel E according to the first embodiment, the control terminal of the select transistor SLT2 is connected to any one of the control signals SL2A to SL2D. Which control signal is connected to the select transistor SLT2 is determined in accordance with the column in which the pixel E is arranged in the pixel unit GU1. The select transistor SLT2 of the pixel E arranged in the same column as the column in which the pixel A is arranged is connected to the control signal SL2A. The select transistor SLT2 of the pixel E arranged in the same column as the column in which the pixel B is arranged is connected to the control signal SL2B. The select transistor SLT2 of the pixel E arranged in the same column as the column in which the pixel C is arranged is connected to the control signal SL2C. The select transistor SLT2 of the pixel E arranged in the same column as the column in which the pixel D is arranged is connected to the control signal SL2D.

In the pixel E according to the first embodiment, the control terminal of the select transistor SLT3 is connected to any one of the control signals SL3A to SL3D. Which control signal is connected to the select transistor SLT3 is determined in accordance with the column in which the pixel E is arranged in the pixel unit GU1. The select transistor SLT3 of the pixel E arranged in the same column as the column in which the pixel A is arranged is connected to the control signal SL3A. The select transistor SLT3 of the pixel E arranged in the same column as the column in which the pixel B is arranged is connected to the control signal SL3B. The select transistor SLT3 of the pixel E arranged in the same column as the column in which the pixel C is arranged is connected to the control signal SL3C. The select transistor SLT3 of the pixel E arranged in the same column as the column in which the pixel D is arranged is connected to the control signal SL3D.

In the pixel E according to the first embodiment, the control terminal of the select transistor SLT4 is connected to any one of the control signals SL4A to SL4D. Which control signal is connected to the select transistor SLT4 is determined in accordance with the column in which the pixel E is arranged in the pixel unit GU1. The select transistor SLT4 of the pixel E arranged in the same column as the column in which the pixel A is arranged is connected to the control signal SL4A. The select transistor SLT4 of the pixel E arranged in the same column as the column in which the pixel B is arranged is connected to the control signal SL4B. The select transistor SLT4 of the pixel E arranged in the same column as the column in which the pixel C is arranged is connected to the control signal SL4C. The select transistor SLT4 of the pixel E arranged in the same column as the column in which the pixel D is arranged is connected to the control signal SL4D.

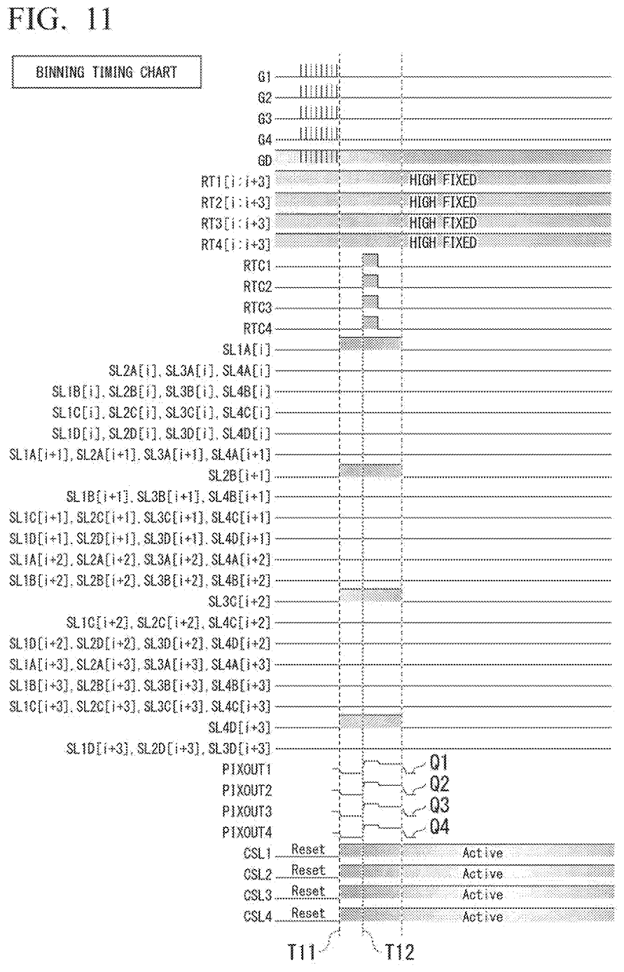

FIG. 10 is a diagram showing an example of a wiring image in the pixel array according to the first embodiment. In this diagram, i indicates a row number.

In the pixel unit GU1 of the pixel array 11 shown in this diagram, the pixel A is arranged at the left end of the i-th row, that is, at the position coordinates (1, 1). The pixel B is arranged at the second position from the left in the (i+1)-th row, that is, at the position coordinates (2, 2). The pixel C is arranged at the third position from the left in the (i+2)-th row, that is, at the position coordinates (3, 3). The pixel D is arranged at the fourth position from the left in the (i+3)-th row, that is, at the position coordinates (4, 4). The pixel E is arranged at positions other than the positions at which the pixel A to the pixel D are arranged in the pixel unit GU1.

The wiring of the pixel array 11 according to the first embodiment is basically the same as the wiring of the pixel array in the related art, but the wiring of the control signal SL is different.

The pixels arranged in the i-th row are wired with the control signals SL1A[i] to SL4A[i] for controlling the select transistors SLT (SLT1 to SLT4) of the pixel A, the control signals SL1B[i] to SL4B[i] for controlling the select transistors SLT (SLT1 to SLT4) of the pixel B, the control signals SL1C[i] to SL4C[i] for controlling the select transistors SLT (SLT1 to SLT4) of the pixel C, and the control signals SL1D[i] to SL4D[i] for controlling the select transistors SLT (SLT1 to SLT4) of the pixel D.

The pixels arranged in the (i+1)-th row are wired with the control signals SL1A[i+1] to SL4A[i+1] for controlling the select transistors SLT (SLT1 to SLT4) of the pixel A, the control signals SL1B[i+1] to SL4B[i+1] for controlling the select transistors SLT (SLT1 to SLT4) of the pixel B, the control signals SL1C[i+1] to SL4C[i+1] for controlling the select transistors SLT (SLT1 to SLT4) of the pixel C, and the control signals SL1D[i+1] to SL4D[i+1] for controlling the select transistors SLT (SLT1 to SLT4) of the Pixel D.

The pixels arranged in the (i+2)-th row are wired with the control signals SL1A[i+2] to SL4A[i+2] for controlling the select transistors SLT (SLT1 to SLT4) of the pixel A, the control signals SL1B[i+2] to SL4B[i+2] for controlling the select transistors SLT (SLT1 to SLT4) of the pixel B, the control signals SL1C[i+2] to SL4C[i+2] for controlling the select transistors SLT (SLT1 to SLT4) of the pixel C, and the control signals SL1D[i+2] to SL4D[i+2] for controlling the select transistors SLT (SLT1 to SLT4) of the pixel D.

The pixels arranged in the (i+3)-th row are wired with the control signals SL1A[i+3] to SL4A[i+3] for controlling the select transistors SLT (SLT1 to SLT4) of the pixel A, the control signals SL1B[i+3] to SL4B[i+3] for controlling the select transistors SLT (SLT1 to SLT4) of the pixel B, the control signals SL1C[i+3] to SL4C[i+3] for controlling the select transistors SLT (SLT1 to SLT4) of the pixel C, and the control signals SL1D[i+3] to SL4D[i+3] for controlling the select transistors SLT (SLT1 to SLT4) of the pixel D.

FIG. 11 is a timing chart showing the driving of the pixel during the binning operation in the first embodiment. In this diagram, a horizontal axis represents time, and a vertical axis represents a waveform of a control signal. The control signals indicate, in order from the top, the control signals G1 to G4, the control signal GD, the control signals RT1[i:i+3], RT2[i:i+3], RT3[i:i+3], and RT4[i:i+3], the control signals RTC1 to RTC4, the control signal SLnX[i+k], the output signals PIXOUT1 to PIXOUT4, and the control signals CSL1 to CSL4. However, the subscript n of the control signal SL is an integer of 1 to 4, X is any of A to E, k is an integer of 0 to 3, and i indicates the row number.

In the binning operation, the pixel drive circuit 12 first fixes the control signal RT to a high (H) state and fixes the reset transistors RST (RST1 to RST4) of all the pixels in the pixel unit GU1 to the ON state.

Further, the pixel drive circuit 12 fixes the control signal SL different from the control signal SL1A[i] in the i-th row, that is, the control signals SL2A[i] to SL4A[i], SL1B[i] to SL4B[i], SL1C[i] to SL4C[i], and SL1D[i] to SL4D[i], to the L state.

Further, the pixel drive circuit 12 fixes the control signal SL different from the control signal SL2B[i+1] in the (i+1)-th row, that is, the control signals SL1A[i+1] to SL4A[i+1], SL1B[i+1], SL3B[i+1] to SL4B[i+1], SL1C[i+1] to SL4C[i+1], and SL1D[i+1] to SL4D[i+1], to the L state.

Further, the pixel drive circuit 12 fixes the control signal SL different from the control signal SL3C[i+2] in the (i+2)-th row, that is, the control signals SL1A[i+2] to SL4A[i+2], SL1B[i+2] to SL4B[i+2], SL1C[i+2] to SL2C[i+2], SL4C[i+2], and SL1D[i+2] to SL4D[i+2], to the L state.

Further, the pixel drive circuit 12 fixes the control signal SL different from the control signal SL4D[i+3] in the (i+3)-th row, that is, the control signals SL1A[i+3] to SL4A[i+3], SL1B[i+3] to SL4B[i+3], SL1C[i+3] to SL4C[i+3], and SL1D[i+3], to SL3D[i+3] to the L state.

Further, the pixel drive circuit 12 resets the output of the selection circuit CSEL by setting the control signals CSL (CSL1 to CSL4) to the L state.

In a period up to time T11, the pixel drive circuit 12 turns on the transfer transistors GT (GT1 to GT4) by the control signals G (G1 to G4) and causes the charge accumulation units CS (CS1 to CS4) to accumulate the charge, as in the driving of the pixel in the related art. Further, the pixel drive circuit 12 turns off the charge discharge transistor DT by the control signal GD while the charge accumulation units CS (CS1 to CS4) accumulate the charge.

At time T11, the pixel drive circuit 12 sets the control signals SL1A[i], SL2B[i+1], SL3C[i+2], and SL4D[i+3] to the H state.

In addition, at the time T11, the control signals CSL1 to CSL4 are set to the H state (active).

Accordingly, the pixel A is caused to output, to the output line PIXOUT1, a pixel value (output signal) corresponding to charge accumulated in the charge accumulation unit CS1, which has been summed by binning.

In addition, the pixel B is caused to output, to the output line PIXOUT2, a pixel value (output signal) corresponding to charge accumulated in the charge accumulation unit CS2, which has been summed by binning.

The pixel C is caused to output, to the output line PIXOUT3, a pixel value (output signal) corresponding to charge accumulated in the charge accumulation unit CS3, which has been summed by binning.

The pixel D is caused to output, to the output line PIXOUT4, a pixel value (output signal) corresponding to charge accumulated in the charge accumulation unit CS4, which has been summed by binning.

At time T12, the pixel drive circuit 12 sets the control signals RTC (RTC1 to RTC4) to the H state to reset the charge accumulated in the charge accumulation units CS (CS1 to CS4) in the pixel unit GU1.

### Second Embodiment

Here, a second embodiment will be described. In the first embodiment described above, the number of control signals SL is four times that of the pixel unit GU1 in the related art, and there is a possibility of the wiring area increasing. From such a viewpoint, in the present embodiment, the number of control signals SL is reduced as compared with the first embodiment, and the readout time is set to be the same as that in the first embodiment.

In the present embodiment, one control signal SLX is further added to the control signals SL (SL1 to SL4) used for controlling the select transistors SLT in the pixel array 11. X is any one of A to D corresponding to four types (pixel A to pixel D) of the pixels 10.

Specifically, in addition to the four control signals SL (SL1 to SL4) in the related art provided for each row of the pixel array 11, a control signal SLA connected to the control terminal of the select transistor SLT1 of the pixel A is added to the row in which the pixel A is arranged. A control signal SLB connected to the control terminal of the select transistor SLT2 of the pixel B is added to the row in which the pixel B is arranged. A control signal SLC connected to the control terminal of the select transistor SLT3 of the pixel C is added to the row in which the pixel C is arranged. A control signal SLD connected to the control terminal of the select transistor SLT4 of the pixel D is added to the row in which the pixel D is arranged. As a result, the selection of the select transistor SLT can be controlled for each column. Moreover, in the present embodiment, the number of control signals SL can be kept to five, which is smaller than that (16) in the first embodiment.

The configuration of the pixel 10 (pixel A to pixel E) in the second embodiment is the same as the configuration of the pixel (pixel A to pixel E) in the related art, except for the connection of the control signal SL.

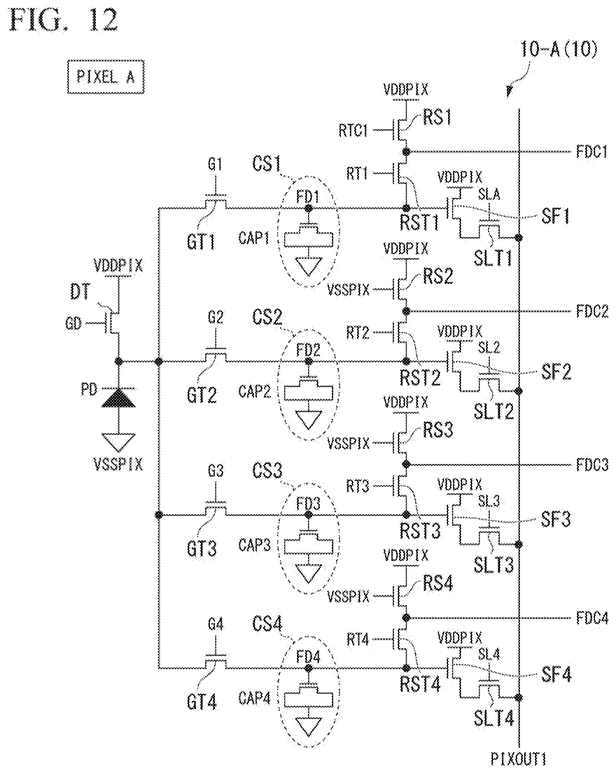

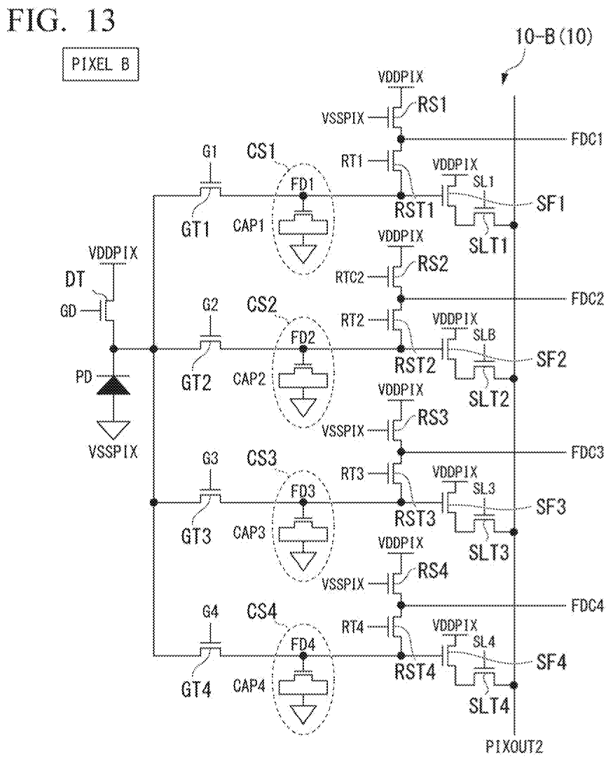

FIG. 12 is a diagram showing an example of the pixel A according to the second embodiment.

As shown in FIG. 12, the basic configuration of the pixel A according to the second embodiment is the same as that of the pixel A in the related art, but has different connection of the control signal (selection signal) of the select transistor SLT1.

In the pixel A according to the second embodiment, the control terminal of the select transistor SLT1 is connected to the control signal SLA.

FIG. 13 is a diagram showing an example of the pixel B according to the second embodiment.

As shown in FIG. 13, the basic configuration of the pixel B according to the second embodiment is the same as that of the pixel B in the related art, but has different connection of the control signal (selection signal) of the select transistor SLT2.

In the pixel B according to the second embodiment, the control terminal of the select transistor SLT2 is connected to the control signal SLB.

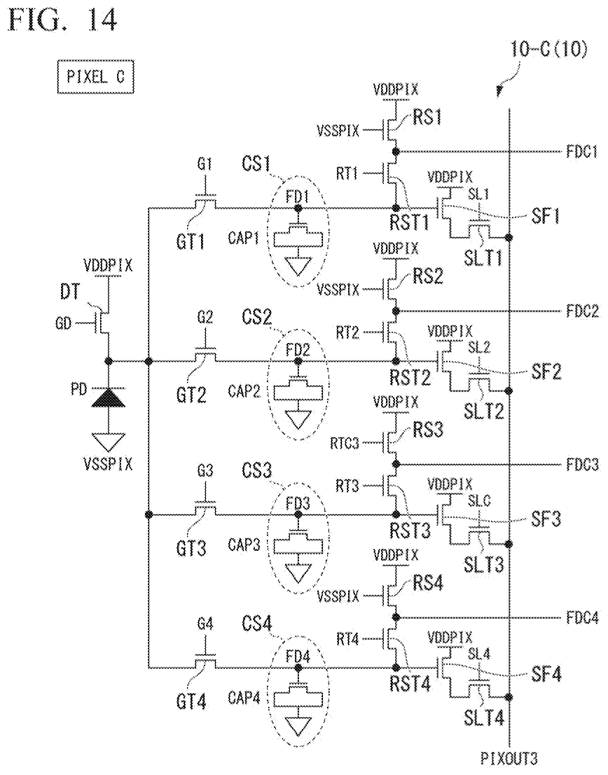

FIG. 14 is a diagram showing an example of the pixel C according to the second embodiment.

As shown in FIG. 14, the basic configuration of the pixel C according to the second embodiment is the same as that of the pixel C in the related art, but has different connection of the control signal (selection signal) of the select transistor SLT3.

In the pixel C according to the second embodiment, the control terminal of the select transistor SLT3 is connected to the control signal SLC.

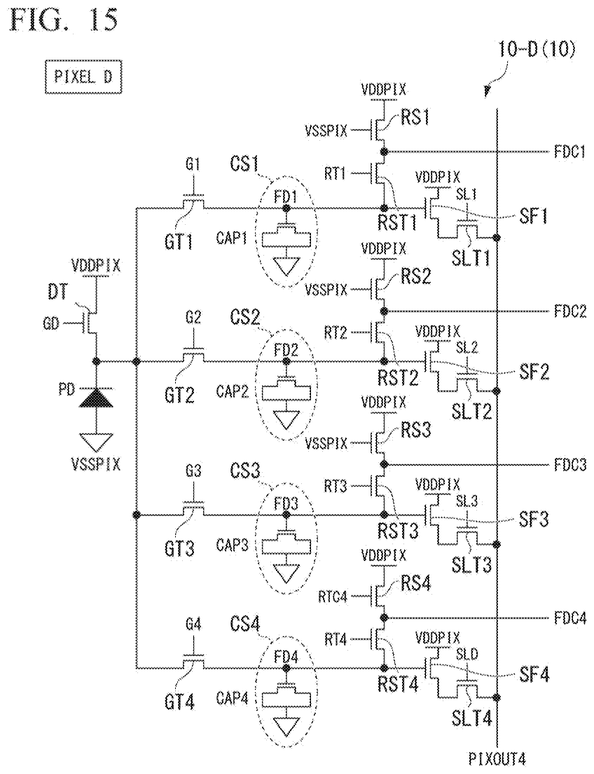

FIG. 15 is a diagram showing an example of the pixel D according to the second embodiment.

As shown in FIG. 15, the basic configuration of the pixel D according to the second embodiment is the same as that of the pixel D in the related art, but has different connection of the control signal (selection signal) of the select transistor SLT4.

In the pixel D according to the second embodiment, the control terminal of the select transistor SLT4 is connected to the control signal SLD.

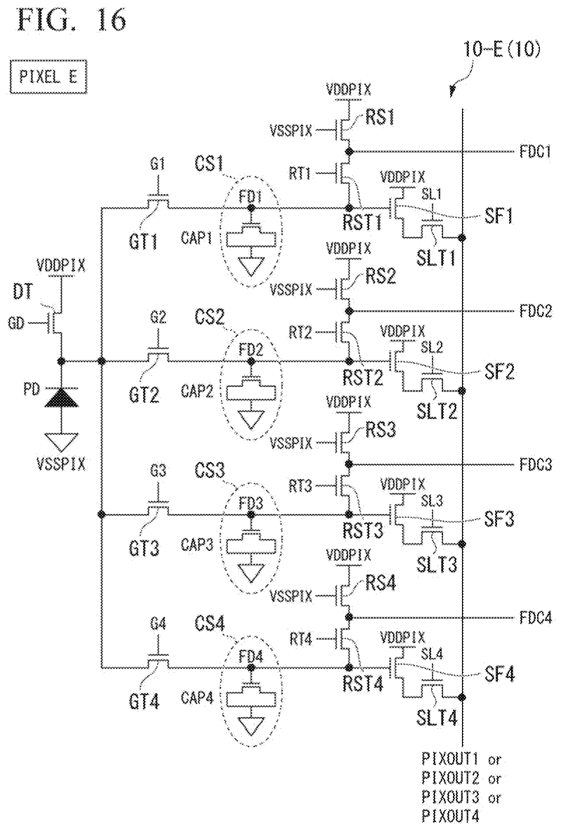

FIG. 16 is a diagram showing an example of the pixel E according to the second embodiment.

As shown in FIG. 16, the configuration of the pixel E according to the second embodiment is the same as that of the pixel E in the related art.

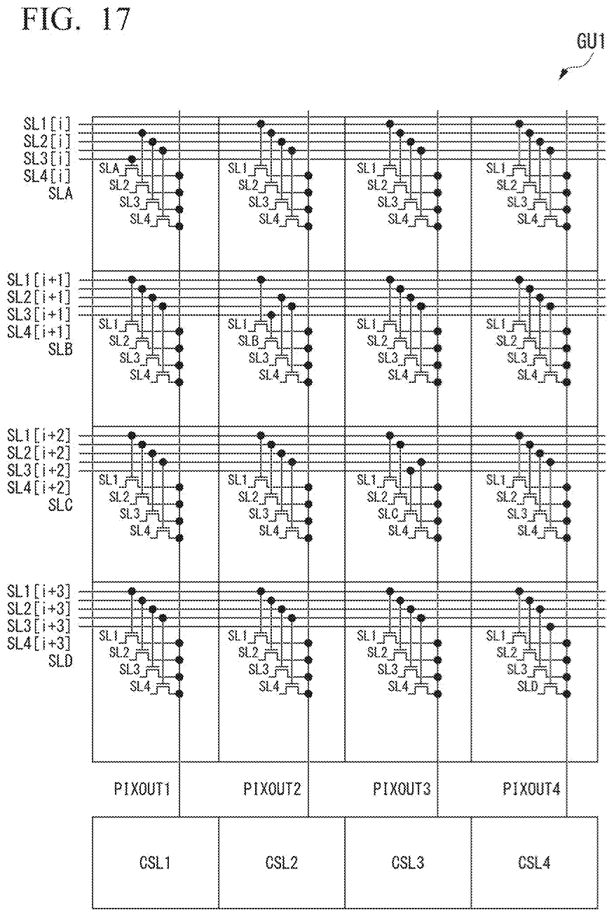

FIG. 17 is a diagram showing an example of a wiring image in the pixel array according to the second embodiment. In this diagram, i indicates a row number.

In the pixel unit GU1 of the pixel array 11 shown in this diagram, the pixel A is arranged at the left end of the i-th row, that is, at the position coordinates (1, 1). The pixel B is arranged at the second position from the left in the (i+1)-th row, that is, at the position coordinates (2, 2). The pixel C is arranged at the third position from the left in the (i+2)-th row, that is, at the position coordinates (3, 3). The pixel D is arranged at the fourth position from the left in the (i+3)-th row, that is, at the position coordinates (4, 4). The pixel E is arranged at position, other than the positions at which the pixel A to the pixel D are arranged in the pixel unit GU1.

The wiring of the pixel array 11 according to the second embodiment is basically the same as the wiring of the pixel array in the related art, but the wiring of the control signal SL is different.

The control signal SLA for controlling the select transistor SLT1 of the pixel A is wired to the pixel arranged in the i-th row. Further, the control signal SL for controlling the remaining select transistors SLT2 to SLT4 of the pixel A and the select transistors SLT (SLT1 to SLT4) included in the pixel E arranged in the i-th row is the same as that of the pixel in the related art.

The control signal SLB for controlling the select transistor SLT2 of the pixel B is wired to the pixel arranged in the (i+1)-th row. In addition, the control signal SL for controlling the remaining select transistors SLT1, SLT3, and SLT4 of the pixel B and the select transistors SLT (SLT1 to SLT4) included in the pixel E arranged in the (i+1)-th row is the same as that of the pixel in the related art.

The control signal SLC for controlling the select transistor SLT3 of the pixel C is wired to the pixel arranged in the (i+2)-th row. In addition, the control signal SL for controlling the remaining select transistors SLT1 to SLT2 and SLT4 of the pixel C and the select transistors SLT (SLT1 to SLT4) included in the pixel E arranged in the (i+2)-th row is the same as that of the pixel in the related art.

The control signal SLD for controlling the select transistor SLT4 of the pixel D is wired to the pixel arranged in the (i+3)-th row. In addition, the control signal SL for controlling the remaining select transistors SLT1 to SLT2 and SLT4 of the pixel D and the select transistors SLT (SLT1 to SLT4) included in the pixel E arranged in the (i+3)-th row is the same as that of the pixel in the related art.

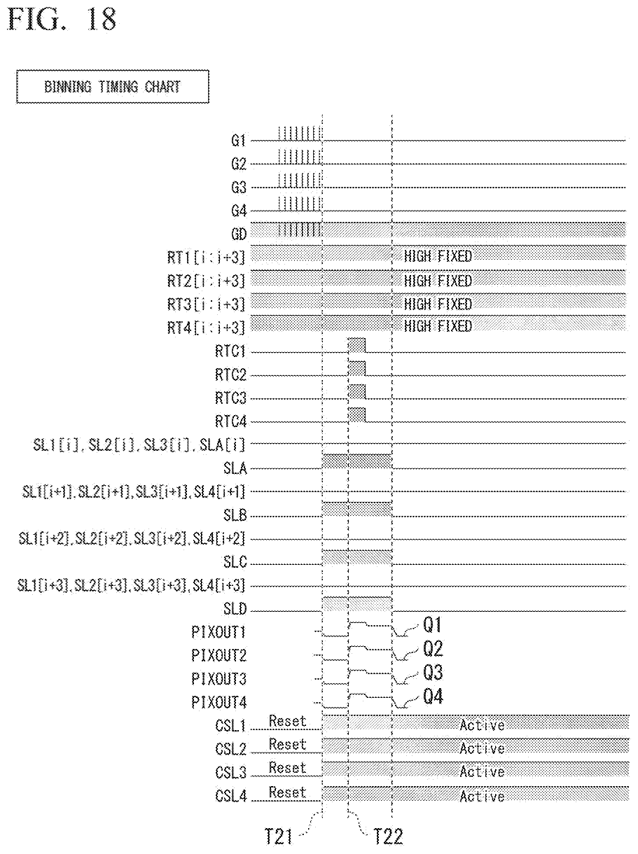

FIG. 18 is a timing chart showing the driving of the pixel during the binning operation in the second embodiment. In this diagram, a horizontal axis represents time, and a vertical axis represents a waveform of a control signal. The control signals are shown in order from the top, the control signals G1 to G4, the control signal GD, the control signals RT1[i:i+3], RT2[i:i+3], RT3[i:i+3], and RT4[i:i+3], the control signals RTC1 to RTC4, the control signals SLn[i+k], SLA, SLB, SLC, and SLD, the output signals PIXOUT1 to PIXOUT4, and the control signals CSL1 to CSL4. However, the subscript n of the control signal SL is an integer of 1 to 4, k is an integer of 0 to 3, and i indicates a row number.

In the binning operation, the pixel drive circuit 12 first fixes the control signal RT to a high (H) state and fixes the reset transistors RST (RST1 to RST4) of all the pixels in the pixel unit GU1 to the ON state.

In addition, the pixel drive circuit 12 fixes the control signal SL different from the control signal SLA in the i-th row, that is, the control signals SL1[i] to SL4[i], to the L state.

In addition, the pixel drive circuit 12 fixes the control signal SL different from the control signal SLB in the (i+1)-th row, that is, the control signals SL1[i+1] to SL4[i+1], to the L state.

In addition, the pixel drive circuit 12 fixes the control signal SL different from the control signal SLC in the (i+2)-th row, that is, the control signals SL1[i+2] to SL4[i+2], to the L state.

In addition, the pixel drive circuit 12 fixes the control signal SL different from the control signal SLD in the (i+3)-th row, that is, the control signals SL1[i+3] to SL4[i+3], to the L state.

Further, the pixel drive circuit 12 resets the output of the selection circuit CSEL by setting the control signals CSL (CSL1 to CSL4) to the L state.

In a period up to time T21, the pixel drive circuit 12 turns on the transfer transistors GT (GT1 to GT4) by the control signals G (G1 to G4) and causes the charge accumulation units CS (CS1 to CS4) to accumulate the charge, as in the driving of the pixel in the related art. Further, the pixel drive circuit 12 turns off the charge discharge transistor DT by the control signal GD while the charge accumulation units CS (CS1 to CS4) accumulate the charge.

At the time T21, the pixel drive circuit 12 sets the control signals SLA, SLB, SLC, and SLD to the H state.

In addition, at the time T21, the control signals CSL1 to CSL4 are set to the H state (active).

Accordingly, the pixel A is caused to output, to the output line PIXOUT1, a pixel value (output signal) corresponding to charge accumulated in the charge accumulation unit CS1, which has been summed by binning.

In addition, the pixel B is caused to output, to the output line PIXOUT2, a pixel value (output signal) corresponding to charge accumulated in the charge accumulation unit CS2, which has been summed by binning.

The pixel C is caused to output, to the output line PIXOUT3, a pixel value (output signal) corresponding to charge accumulated in the charge accumulation unit CS3, which has been summed by binning.

The pixel D is caused to output, to the output line PIXOUT4, a pixel value (output signal) corresponding to charge accumulated in the charge accumulation unit CS4, which has been summed by binning.

At time T22, the pixel drive circuit 12 sets the control signals RTC (RTC1 to RTC4) to the H state to reset the charge accumulated in the charge accumulation units CS (CS1 to CS4) in the pixel unit GU1.

In the above-described embodiment, as shown in FIG. 3, as an example, a case has been described in which the pixel A, the pixel B, the pixel C, and the pixel D are arranged in order in the direction from the upper left end to the lower right end in the pixel unit GU1. However, the present invention is not limited to this.

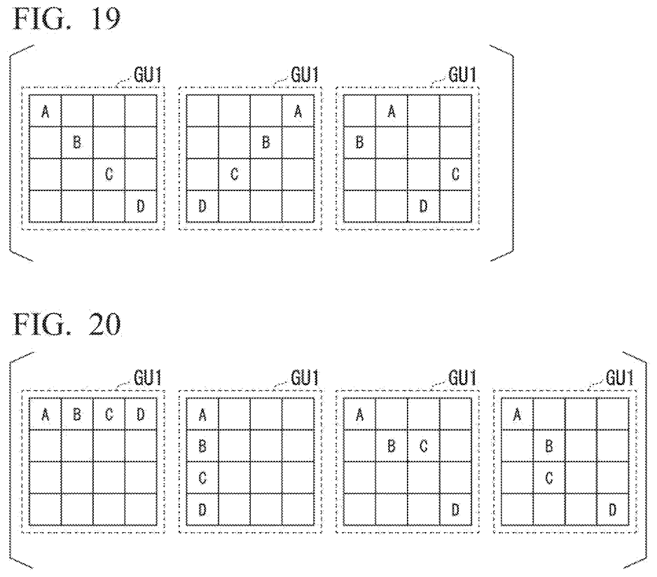

Examples of the pixel arrangement that can be adopted in the embodiment and examples of the pixel arrangement that cannot be adopted will be described with reference to FIGS. 19 and 20.

FIG. 19 is a diagram showing examples of the pixel arrangement of the pixel unit GU1 that can be adopted in the embodiment.

The same pixel array as in the embodiment is shown on the left side of this diagram. That is, the pixel A is arranged at the position coordinates (1, 1), the pixel B is arranged at the position coordinates (2, 2), the pixel C is arranged at the position coordinates (3, 3), and the pixel D is arranged at the position coordinates (4, 4). This arrangement can be adopted in the present embodiment.

In the center of this diagram, an arrangement example is shown in which the pixel A, the pixel B, the pixel C, and the pixel D are arranged in order in the direction from the upper right end to the lower left end. That is, the pixel A is arranged at the position coordinates (4, 1), the pixel B is arranged at the position coordinates (3, 2), the pixel C is arranged at the position coordinates (2, 3), and the pixel D is arranged at the position coordinates (1, 4). This arrangement can be adopted in the present embodiment.

On the right side of this diagram, the pixel A is arranged at the position coordinates (2, 1), the pixel B is arranged at the position coordinates (1, 2), the pixel C is arranged at the position coordinates (4, 3), and the pixel D is arranged at the position coordinates (3, 4). This arrangement can be adopted in the present embodiment.

FIG. 20 is a diagram showing examples of the pixel arrangement of the pixel unit GU1 that cannot be adopted in the embodiment.

On the left side of this diagram, an arrangement example is shown in which the pixel A, the pixel B, the pixel C, and the pixel D are arranged in order in the horizontal direction. That is, the pixel A is arranged at the position coordinates (1, 1), the pixel B is arranged at the position coordinates (2, 1), the pixel C is arranged at the position coordinates (3, 1), and the pixel D is arranged at the position coordinates (4, 1). This arrangement cannot be adopted in the present embodiment.

At the left center of this diagram, an arrangement example is shown in which the pixel A, the pixel B, the pixel C, and the pixel D are arranged in order in the up-down direction. That is, the pixel A is arranged at the position coordinates (1, 1), the pixel B is arranged at the position coordinates (1, 2), the pixel C is arranged at the position coordinates (1, 3), and the pixel D is arranged at the position coordinates (1, 4). This arrangement cannot be adopted in the present embodiment.

At the right center of this diagram, an arrangement example is shown in which at least two pixels of the pixel A to the pixel D are arranged side by side in the horizontal direction. That is, the pixel A is arranged at the position coordinates (1, 1), the pixel B is arranged at the position coordinates (2, 2), the pixel C is arranged at the position coordinates (3, 2), and the pixel D is arranged at the position coordinates (4, 4). This arrangement cannot be adopted in the present embodiment.

On the right side of this diagram, an arrangement example is shown in which at least two pixels of the pixel A to the pixel D are arranged side by side in the up-down direction. That is, the pixel A is arranged at the position coordinates (1, 1), the pixel B is arranged at the position coordinates (2, 2), the pixel C is arranged at the position coordinates (2, 3), and the pixel D is arranged at the position coordinates (4, 4). This arrangement cannot be adopted in the present embodiment.

As described above, the distance image capturing element 1 according to the embodiment includes the pixel array 11 in which the plurality of pixels 10 are arranged in a two-dimensional matrix, and the pixel drive circuit 12 that drives the pixels 10. The pixel 10 includes one photoelectric conversion element PD that generates the charge corresponding to incident light, m (m is an integer of 2 or more, for example, m=4) charge accumulation units CS that accumulate the charge, and m select transistors SLT that are provided to correspond to the m charge accumulation units CS and output the voltage signals corresponding to the amounts of charge accumulated in the charge accumulation units CS. In the pixel array 11, in the m×m binning operation, the pixel A (first pixel) that outputs a binned addition value of the output signal PIXOUT (specific voltage signal) corresponding to the amount of charge accumulated in one charge accumulation unit CS (first charge accumulation unit) among the m charge accumulation units included in the pixel, and the pixels B to D (second pixels) that do not output the binned addition value of the output signal PIXOUT (specific voltage signal) are arranged.

Among the m select transistors SLT included in the pixel A (first pixel), a control terminal of the SLT1 (first select transistor that outputs an added value of the first voltage signal) and a control terminal of the select transistor SLT1 (first select transistor) included in the pixel B to the pixel E (second pixel) are connected to different selection signals.

For example, as shown in FIGS. 12 to 16, while the control terminal of the select transistor SLT1 of the pixel A is connected to the control signal SLA, the control terminals of the select transistors SLT1 of the pixel B to the pixel E are connected to the control signal SL1.

As a result, in the distance image capturing element 1 according to the embodiment, the select transistor SLT can be controlled for each column, and the time required for reading out the pixel signal of each of the plurality of charge accumulation units when performing the binning operation can be shortened.

Further, in the distance image capturing element 1 according to the embodiment, the control terminals of the m select transistors SLT (for example, the select transistors SLT1 to SLT4 in the case of m=4) included in the pixel A (first pixel) and the control terminals of the select transistors SLT included in the pixels 10 (pixel B to pixel E) other than the pixel A (first pixel) arranged in the pixel array 11 are connected to different selection signals.

For example, as shown in FIGS. 5 and 6, while the control terminal of the select transistor SLT1 of the pixel A is connected to the control signal SL1A, the control terminal of the select transistor SLT1 of the pixel B is connected to the control signal SL1B.

Accordingly, the distance image capturing element 1 according to the embodiment has the same effect as the above-described effect.

Further, in the distance image capturing element 1 according to the embodiment, the pixel array 11 includes at least m types of pixels 10 (for example, the pixel A to the pixel D) that are driven differently from each other in the m×m binning operation.

The m types of pixels 10 are pixels 10 that each outputs the binned addition value of the voltage signal corresponding to the amount of charge accumulated in any one charge accumulation unit CS among the m charge accumulation units CS included in the pixel 10.

For each of the m types of pixels 10, a control terminal of a specific select transistor that outputs the binned addition value among the m select transistors SLT included in the pixel 10 and a control terminal of a select transistor corresponding to the specific select transistor among the m select transistors SLT included in the pixel 10 of a different type are connected to different selection signals.

For example, as shown in FIGS. 5 to 9, the control terminal of the select transistor SLT1 of the pixel A is connected to the control signal SL1A, whereas the control terminal of the select transistor SLT1 of the pixel B is connected to the control signal SL1B, the control terminal of the select transistor SLT1 of the pixel C is connected to the control signal SL1C, and the control terminal of the select transistor SLT1 of the pixel D is connected to the control signal SL1D.

Accordingly, the distance image capturing element 1 according to the embodiment has the same effect as the above-described effect.

In addition, in the distance image capturing element 1 according to the embodiment, the pixel 10 includes four charge accumulation units CS (charge accumulation units CS1 to CS4) and four select transistors SLT (select transistors SLT1 to SLT4).

The pixel array 11 includes at least four types of pixels 10 (pixel A to pixel D) that are driven differently from each other in the 4×4 binning operation.

The four types of pixels 10 are the type-A pixel 10-A (pixel A) that outputs the binned addition value of the first voltage signal corresponding to the amount of charge accumulated in the charge accumulation unit CS1 (first charge accumulation unit) among the four charge accumulation units CS1 to CS4 included in the pixel 10, the type-B pixel 10-B (pixel B) that outputs the binned addition value of the second voltage signal corresponding to the amount of charge accumulated in the charge accumulation unit CS2 (second charge accumulation unit), the type-C pixel 10-C (pixel C) that outputs the binned addition value of the third voltage signal corresponding to the amount of charge accumulated in the charge accumulation unit CS3 (third charge accumulation unit), and the type-D pixel 10-D (pixel D) that outputs the binned addition value of the fourth voltage signal corresponding to the amount of charge accumulated in the charge accumulation unit CS4 (fourth charge accumulation unit).

The control terminal of the select transistor SLT1 (first select transistor) that outputs the first voltage signal of the type-A pixel 10-A (pixel A) and the control terminal of the select transistor SLT1 included in the pixel 10 of a different type from the type-A pixel (pixel B to pixel D) are connected to different selection signals.

The control terminal of the select transistor SLT2 (second select transistor) that outputs the second voltage signal of the type-B pixel 10-B (pixel B) and the control terminal of the select transistor SLT2 included in the pixel 10 of a different type from the type-B pixel (pixel A, pixel C, and pixel D) are connected to different selection signals.

The control terminal of the select transistor SLT3 (third select transistor) that outputs the third voltage signal of the type-C pixel 10-C (pixel C) and the control terminal of the select transistor SLT3 included in the pixel 10 of a different type from the type-C pixel (pixel A, pixel B, and pixel D) are connected to different selection signals.

The control terminal of the select transistor SLT4 (fourth select transistor) that outputs the fourth voltage signal of the type-D pixel 10-D (pixel D) and the control terminal of the select transistor SLT4 included in the pixel 10 of a different type from the type-D pixel (pixel A to pixel C) are connected to different selection signals.

Accordingly, the distance image capturing element 1 according to the embodiment has the same effect as the above-described effect.

In addition, in the distance image capturing element 1 according to the embodiment, the pixel 10 includes m reset transistors RST that correspond to the m charge accumulation units CS and reset the charge accumulation unit to a predetermined reset potential supplied from the power supply line, and m control transistors RS that correspond to the m reset transistors RST and are connected between the reset transistor RST and the power supply line.

In the pixel 10, among the m control transistors RS, the control transistor RS corresponding to the specific voltage signal (signal that outputs the binned addition value) is connected to the control wiring RT capable of controlling the conducting state, and the remaining control transistors RS other than the control transistor RS corresponding to the specific voltage signal among the m control transistors RS are fixed in the non-conducting state.

For example, as shown in FIG. 5, in the pixel A, among the four control transistors RS (control transistors RS1 to RS4), the control transistor RS1 corresponding to the first voltage signal (signal that outputs the binned addition value of the voltage signal accumulated in the charge accumulation unit CS1) is connected to the control wiring RT1 capable of controlling the conducting state, and the remaining control transistors SR (control transistors RS2 to RS4) other than the control transistor RS1 corresponding to the first voltage signal among the four control transistors RS (control transistors RS1 to RS4) are fixed in the non-conducting state.

As a result, in the distance image capturing element 1 according to the embodiment, the binning addition can be performed, the added charge can be erased, and the binning operation can be performed.

As described above, the distance image capturing device 100 according to the embodiment includes the light source unit 2, the light receiving unit 3, and the distance image processing unit 4. The light source unit 2 irradiates the subject OB with the light pulse. The light receiving unit 3 includes the distance image capturing element 1. The distance image processing unit 4 controls the pixel drive circuit 12 to accumulate the charge in each of the charge accumulation units CS, and calculates the distance to the subject OB based on the binned addition value of the voltage signal corresponding to the amount of charge accumulated in each of the charge accumulation units CS. As a result, in the distance image capturing device 100 according to the embodiment, the distance calculation can be performed in the sensor circuit (distance image capturing device 100), the voltage signal corresponding to the amount of charge accumulated in any of the charge accumulation units CS is sequentially held in the memory provided inside or outside the distance image capturing device 100, it is not necessary to calculate the distance after the voltage signals used for the distance calculation are collected, the memory capacity can be reduced, and the time required for the distance calculation can be shortened.

The present invention is not limited to the above-described embodiments, and can be changed without departing from the gist of the present invention.

For example, in the above-described embodiments, the example has been described in which the pixel 10 includes four charge accumulation units CS, but the present invention is not limited to this, and the pixel 10 may include other numbers (m or less) of charge accumulation units CS as long as the pixel 10 includes two or more charge accumulation units CS.

In addition, in the above-described embodiments, the example has been described in which the pixel array 11 includes four types of pixels 10 as an example of the m types of pixels 10, but the present invention is not limited to this.

For example, when performing binning of (2×2) pixels, at least two types of pixels 10 may be provided to output the binned addition value of the voltage signal corresponding to the amount of charge accumulated in each of the two charge accumulation units CS1 and CS2.

In addition, for example, when performing binning of (3×3) pixels, at least three types of pixels 10 may be provided to output the binned addition value of the voltage signal corresponding to the amount of charge accumulated in each of the three charge accumulation units CS1 to CS3.

In addition, when performing binning of five or more, for example, (5×5), pixels, at least five types of pixels 10 may be provided to output the binned addition value of the voltage signal corresponding to the amount of charge accumulated in each of the five charge accumulation units CS1 to CS5.

In addition, in the above-described embodiments, the example has been described in which the photoelectric conversion element PD is a buried photodiode that photoelectrically converts incident light to generate a charge and accumulates the generated charge, but the present invention is not limited to this, and the structure of the photoelectric conversion element PD may be arbitrary. The photoelectric conversion element PD may be, for example, a PN photodiode having a structure in which a P-type semiconductor and an N-type semiconductor are joined, or a PIN photodiode having a structure in which an I-type semiconductor is sandwiched between a P-type semiconductor and an N-type semiconductor. In addition, the photoelectric conversion element PD is not limited to the photodiode, and may be, for example, a photogate-type photoelectric conversion element.

In addition, in the above-described embodiments, the example in which each transistor of the transfer transistor GT (GT1 to GT4), the charge discharge transistor DT, the reset transistor RST (RST1 to RST4), the source follower transistor SF (SF1 to SF4), the select transistor SLT (SLT1 to SLT4), and the control transistor RS (RS1 to RS4) is an NMOS transistor has been described, but the present invention is not limited to this, and for example, another transistor such as a PMOS transistor may be used.

All or a part of the distance image capturing element 1 and the distance image capturing device 100 in the above-described embodiments may be implemented by a computer. In that case, a program for implementing the function may be recorded on a computer-readable recording medium, and the program recorded on the recording medium may be read into a computer system and executed to implement the function. The term “computer system” as used herein includes an OS or hardware such as a peripheral device. Further, the term “computer-readable recording medium” refers to a portable medium such as a flexible disk, a magneto-optical disk, a ROM, or a CD-ROM, or a storage device such as a hard disk built in the computer system. Furthermore, the term “computer-readable recording medium” may also include a medium that dynamically holds a program for a short period of time, such as a communication line in a case of transmitting a program via a network such as the Internet or a communication line such as a telephone line, or a medium that holds a program for a certain period of time, such as a volatile memory inside a computer system that is a server or a client in that case. In addition, the above-described program may be a program for implementing some of the above-described functions, may be a program that can implement the above-described functions in combination with a program already recorded in a computer system, or may be a program implemented by using a programmable logic device such as an FPGA.

Although the embodiments of the present invention have been described in detail above with reference to the accompanying drawings, the specific configuration is not limited to the embodiments, and the present invention also includes designs, device configurations, correction processing, filtering processing, and the like within the range not departing from the gist of the present invention.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: distance image capturing element
2: light source unit
3: light receiving unit
10: pixel
11: pixel array
12: pixel drive circuit
100: distance image capturing device
CS, CS1, CS2, CS3, CS4: charge accumulation unit
FD, FD1, FD2, FD3, FD4: floating diffusion
FDC1, FDC2, FDC3, FDC4: floating diffusion
GT, GT1, GT2, GT3, GT4: transfer transistor
DT: charge discharge transistor
PD: photoelectric conversion element
PO: light pulse
RL: reflected light
RS, RS1, RS2, RS3, RS4: control transistor
RST, RST1, RST2, RST3, RST4: reset transistor
SF, SF1, SF2, SF3, SF4: source follower transistor
SLT, SLT1, SLT2, SLT3, SLT4: select transistor
PIXOUT: output line
SL, SL1, SL2, SL3, SL4: control signal (selection signal)
SL1A, SL2B, SL3C, SL4D: control signal (selection signal)
SLA, SLB, SLC, SLD: control signal (selection signal)
RT, RT1, RT2, RT3, RT4: control signal (control wiring)

What is claimed is:

1. A distance image capturing element comprising:
a pixel array in which a plurality of pixels are arranged in a two-dimensional matrix; and
a pixel drive circuit that drives the pixels,
wherein the pixels each includes
one photoelectric conversion element that generates charge corresponding to incident light,
m (m is an integer of 2 or more) charge accumulation units that accumulate the charge, and
m select transistors that are provided to correspond to the m charge accumulation units and output voltage signals corresponding to amounts of charge accumulated in the charge accumulation units,
in the pixel array, in an m×m binning operation, a first pixel that outputs a binned addition value of a specific voltage signal corresponding to an amount of charge accumulated in one of the m charge accumulation units included in the pixels, and a second pixel that does not output the binned addition value of the specific voltage signal are arranged, and
a control terminal of a specific select transistor that outputs an added value of the specific voltage signal among the m select transistors included in the first pixel, and a control terminal of the specific select transistor included in the second pixel are connected to different selection signals.

2. The distance image capturing element according to claim 1,
wherein a control terminal of each of the m select transistors included in the first pixel and a control terminal of each of the select transistors included in the second pixel are connected to different selection signals.

3. The distance image capturing element according to claim 1,
wherein the pixel array includes at least m types of the pixels that are driven differently from each other in an m×m binning operation,
the m types of the pixels are the pixels each of which outputs a binned addition value of a voltage signal corresponding to an amount of charge accumulated in any one of the m charge accumulation units included in the pixels, and
for each of the m types of the pixels, a control terminal of the specific select transistor that outputs the binned addition value among the m select transistors included in the pixels, and a control terminal of the select transistor that corresponds to the specific select transistor among the m select transistors included in a pixel of a different type are connected to different selection signals.

4. The distance image capturing element according to claim 1,
wherein the pixels each includes
four charge accumulation units, and
four select transistors,
the pixel array includes at least four types of the pixels that are driven differently from each other in a 4×4 binning operation,
the four types of the pixels are:, among the four charge accumulation units included in the pixel, a type-A pixel that outputs a binned addition value of a first voltage signal corresponding to an amount of charge accumulated in a first charge accumulation unit; a type-B pixel that outputs a binned addition value of a second voltage signal corresponding to an amount of charge accumulated in a second charge accumulation unit;
a type-C pixel that outputs a binned addition value of a third voltage signal corresponding to an amount of charge accumulated in a third charge accumulation unit;
and a type-D pixel that outputs a binned addition value of a fourth voltage signal corresponding to an amount of charge accumulated in a fourth charge accumulation unit,
a control terminal of a first select transistor that outputs the first voltage signal in the type-A pixel, and a control terminal of the first select transistor included in a pixel of a type different from the type-A pixel are connected to different selection signals,
a control terminal of a second select transistor that outputs the second voltage signal in the type-B pixel, and a control terminal of the second select transistor included in a pixel of a type different from the type-B pixel are connected to different selection signals,
a control terminal of a third select transistor that outputs the third voltage signal in the type-C pixel, and a control terminal of the third select transistor included in a pixel of a type different from the type-C pixel are connected to different selection signals, and
a control terminal of a fourth select transistor that outputs the fourth voltage signal in the type-D pixel, and a control terminal of the fourth select transistor included in a pixel of a type different from the type-D pixel are connected to different selection signals.

5. The distance image capturing element according to claim 1,
wherein the pixels each includes
m reset transistors that correspond to the m charge accumulation units and reset the charge accumulation units to a predetermined reset potential supplied from a power supply line, and
m control transistors that correspond to the m reset transistors and are connected between the reset transistors and the power supply line, and
in the pixels, a control transistor corresponding to the specific voltage signal among the m control transistors is connected to a control wiring that controls a conducting state, and the remaining control transistor that is different from the control transistor corresponding to the specific voltage signal among the m control transistors is fixed in a non-conducting state.

6. A distance image capturing device comprising:
a light source unit that irradiates a subject with a light pulse;
a light receiving unit including the distance image capturing element according to claim 1; and
a distance image processing unit that controls the pixel drive circuit so that the charge is accumulated in each of the charge accumulation units, outputs a binned addition value of a voltage signal corresponding to an amount of charge accumulated in each of the charge accumulation units, and calculates a distance to the subject based on the binned addition value corresponding to each of the charge accumulation units.
